(19) United States
(12) Patent Application Publication
(10) Pub. No.: US 2014/0155072 A1
(43) Pub. Date: Jun. 5, 2014

(54) METHOD FOR OPERATING A MOBILE TERMINAL IN A CELLULAR COMMUNICATION NETWORK AND A MOBILE TERMINAL, A DEVICE OF A COMMUNICATION NETWORK, AND A SYSTEM FOR EXECUTING THE METHOD

(71) Applicant: Vodafone Holding GmbH, Dusseldorf (DE)

(72) Inventor: Christoph Hellmann, Neuss (DE)

(21) Appl. No.: 13/911,440

(22) Filed: Jun. 6, 2013

(30) Foreign Application Priority Data
Jun. 6, 2012 (DE) 10 2012 011 243.2

(51) Int. Cl. H04W 36/32

(52) U.S. Cl. CPC H04W 36/32
USPC 455/440

(57) ABSTRACT

A method is provided for operating a mobile terminal operable in at least one communication network for a change of connection in a communication network. The method includes evaluating an information item regarding the local position of the mobile terminal in a service area of a radio cell of a first type with regard to an entry of the mobile terminal into the service area of a radio cell of the first type, which entry is to be expected within a predefined time interval. The method also includes suppressing a change of connection of the mobile terminal to a radio cell of a second type if, based on the result of the evaluation, the entry of the mobile terminal into the service area of the radio cell of the first type can be expected within the predefined time interval.

### TECHNICAL FIELD

The present invention relates to a method for operating a mobile terminal operable in at least one communication network for a change of connection in a communication network, wherein radio cells of a first type and radio cells of a second type are formed by the at least one communication network. In exemplary embodiments of the present invention, voice and/or data transmissions in accordance with a first transmission protocol can be performed in radio cells of the first type, and voice and/or data transmissions in accordance with a second transmission protocol can be performed in radio cells of the second type. In further exemplary embodiments of the present invention, the radio cells of the first type may be operated by a first communication network operator, for instance by a first mobile radio network operator, and voice and/or data transmissions in accordance with a first or second transmission protocol can be performed. The radio cells of the second type may be operated by a second communication network operator, for instance by a second mobile radio network operator. In these exemplary embodiments, however, the voice and/or data transmissions can be performed in accordance with the same first or second transmission protocol as in the radio cells of the first type.

Exemplary embodiments of the present invention relate to, among other things, a method for operating a mobile terminal in a communication network, as for instance a cellular mobile radio network, with radio cells of a first type, for instance in accordance with a first mobile radio standard, and radio cells of a second type, for instance in accordance with a second mobile radio standard. The mobile terminal can be designed for operation both in accordance with the first mobile radio standard and with the second mobile radio standard, and the mobile terminal can furthermore be present in the service area of a radio cell in accordance with the first mobile radio standard and the service area of at least one other radio cell in accordance with the second mobile radio standard. The mobile terminal utilises the radio cell in accordance with the first mobile radio standard for a data connection, and in relation to the utilised radio cell in accordance with the first mobile radio standard, the signal quality necessitates a change of connection to another radio cell during the ongoing data connection. The terminology “first mobile radio standard” and “second mobile radio standard” is presently used for easier readability and is supposed to express that there are two mobile radio standards, namely one mobile radio standard and another mobile radio standard differing from the aforementioned mobile radio standard. It is not intended to establish an order of precedence by the terminology “first” and “second”. The terminology “first mobile radio standard” is particularly not intended to indicate that it is an older mobile radio standard in comparison with the “second mobile radio standard.”

### BACKGROUND INFORMATION

The aforementioned methods for operating a mobile terminal in a cellular mobile radio network are known in the state of the art. Since users of mobile terminals such as mobile telephones may change their location or local position also during an ongoing communication connection, it is possible that during a connection, the user with his mobile terminal will move out of the service area or the range of reception of the radio cell which is used by the mobile terminal for the currently ongoing connection. In this process, the signal quality of the radio cell may decrease with regard to the signal level receivable by the mobile terminal. The connection may be a data connection, where data packages, for example as they are sent for loading Internet pages, pictures, videos, etc., are transmitted unidirectionally or bidirectionally. In such situations, a change to a radio cell with a better signal quality must be performed. Such a change from one radio cell to another is also called handover or handoff. During an ongoing communication connection, the mobile terminal usually measures the signal strength both of the radio cell which it is using for the communication connection and the signal strength of other radio cells which are within the range of reception of the mobile terminal, wherein the results of the measurements are transmitted to the mobile radio network which, in particular on the basis of these results, decides when another radio cell is better suited for continuing the communication connection and causes a corresponding change to that radio cell.

In the event that at a particular location, the operation of a mobile terminal is on principle possible both in accordance with a first mobile radio standard, as e.g. UMTS (UMTS: Universal Mobile Telecommunications System), and in accordance with a second mobile radio standard, as e.g. GSM (GSM: Global System for Mobile Communications), and the mobile terminal, as it is usually the case nowadays in particular for mobile telephones sold in Europe, is configured both for operation in accordance with the first mobile radio standard and for operation in accordance with the second mobile radio standard, it is often the case that a change of connection from one radio cell in accordance with the first mobile radio standard to a radio cell in accordance with the second mobile radio standard is performed. Such a change is also called Intersystem Handover. A change from a radio cell in accordance with a first mobile radio standard to a radio cell in accordance with a second mobile radio standard during an ongoing communication connection will occur in particular if the mobile terminal is present in the service area of a radio cell, i.e. of a single radio cell, in accordance with the first mobile radio standard and the service area of at least one other radio cell in accordance with the second mobile radio standard, and the mobile terminal uses the radio cell in accordance with the first mobile radio standard for the communication connection, wherein the signal quality in relation to the used radio cell in accordance with the first mobile radio standard requires a change of connection to another radio cell during the ongoing communication connection. This may for instance be the case because the user moves out of the service area of the radio cell in accordance with the first mobile radio standard, or because the size of the radio cell decreases with increasing capacity utilisation (so-called “cell breathing”), which may occur in particular with radio cells of UMTS mobile radio networks. Since the mobile terminal in accordance with the aforementioned prerequisites is not present in the service area of another radio cell in accordance with the first mobile radio standard, but in the service area of another radio cell in accordance with the second mobile radio standard, the mobile radio network will cause a change from the radio cell in accordance with the first mobile radio standard to the radio cell in accordance with the second mobile radio standard, so that after the change has been accomplished, the mobile terminal can be operated in the radio cell in accordance with the second mobile radio standard.

Such a change from a radio cell of the first type to a radio cell of the second type during an ongoing communication connection, however, can sometimes be disadvantageous. This is explained in the following by way of example on the basis of a change from a radio cell of the first type, for instance in accordance with a UMTS mobile radio standard, to a radio cell of the second type, for instance a GSM mobile radio standard. Irrespective of that, the described disadvantages can on principle occur, although sometimes in modified form, during a change from a radio cell of a first type to a radio cell of a second type. The radio cells of the first or second type may for instance also be WLAN radio cells, hot-spot radio cells. The radio cells of the first or second type may also be radio cells in accordance with the known mobile radio standards, such as UMTS or GSM, and in particular also in accordance with an LTE mobile radio standard (LTE: Long Term Evolution), a CDMA2000 mobile radio standard (CDMA: Code Division Multiple Access), or any other mobile radio standard.

One disadvantage of a change from a radio cell, for instance in accordance with a UMTS mobile radio standard, to a radio cell in accordance with a GSM mobile radio standard during an ongoing data connection is in particular the delay in data transmission involved in such a change. If the mobile terminal initially uses a radio cell in the UMTS mobile radio network for data transmission, wherein a decreasing signal quality in relation to the used radio cell necessitates a change to another radio cell, the signal quality of a neighbouring radio cell of the UMTS mobile radio network, however, is not good enough yet, or the signal level of the neighbouring cell is not strong enough for receiving a corresponding signal from the neighbouring cell by means of the mobile terminal, or at least not strong enough for use by the mobile terminal, a switch-over of the mobile terminal to GSM/GPRS operation (GPRS: General Packet Radio Service) and a corresponding change from the radio cell in accordance with the UMTS mobile radio standard to the radio cell in accordance with the GSM mobile radio standard, and therefore an intersystem handover, is initiated. This will lead to a disconnection of the data connection in the UMTS mobile radio network, which will be set up again after the change to the radio cell in accordance with the GSM standard has been accomplished. This change from UMTS to GSM/GPRS usually results in an interruption of the data connection for approximately 15 to 20 seconds. Upon re-entry into the service area of a radio cell of the UMTS mobile radio network, which often occurs already a few seconds after the service area of a radio cell of the UMTS mobile radio network has been left, another change from the radio cell of the GSM mobile radio network to a radio cell in accordance with the UMTS mobile radio standard is performed, which usually occurs within a time interval of 4 to 7 seconds, during which the data connection is interrupted again. In total, the data connection is therefore interrupted for a time period of approximately 20 to 30 seconds. This period of interruption and the data connection utilising the General Packet Radio Service in the GSM mobile radio network which is slower in comparison with the UMTS mobile radio standard leads to a delay in relation to data transmission which is clearly perceivable and considered extremely irritating on the part of the user.

### SUMMARY

Against this background, the present invention is based on the problem to improve a method mentioned in the beginning for operating a mobile terminal operable in at least one communication network for the purpose of a change of connection in a communication network with radio cells, as for instance in a cellular mobile radio network. Herein, a reduction of the delay of data transmission, in particular with a quickly occurring re-entry into the service area of a similar radio cell of the communication network, can be achieved.

For the technical solution of this problem, the present invention suggests a method for operating a mobile terminal operable in at least one communication network for a change of connection in a communication network, wherein radio cells of a first type and radio cells of a second type are formed by at least one communication network, comprising the following steps:

evaluating an information item regarding the local position of the mobile terminal in a service area of a radio cell of the first type with regard to an entry of the mobile terminal into the service area of a radio cell of the first type, which entry is to be expected within a predefined time interval;

suppressing a change of connection of the mobile terminal to a radio cell of the second type if, based on the result of the evaluation, the entry of the mobile terminal into the service area of the radio cell of the first type can be expected within the predefined time interval.

In this manner, a mobile terminal in accordance with the present invention can use a data connection via a WLAN as a radio cell of a first type. A radio cell of a UMTS mobile radio network may be available as a radio cell of a second type. According to the invention, it is provided that in the event of non-availability of the WLAN radio cell, in particular due to leaving the service area, a change of connection to the UMTS radio cell is suppressed based on a forecasting evaluation, if the result of the evaluation gives reason to expect that the mobile terminal will enter the service area of a WLAN radio cell within a predefined time interval.

Preferentially, the suppression of the change of connection to another radio cell is initiated by the mobile terminal. Preferentially, in particular the suppression of a change to a radio cell of the second type is initiated by the mobile terminal. Preferentially, changes on the part of the communication network, in particular with regard to handovers to be carried out, are not required. Within the scope of initiating the change of connection, it is provided in a design variant of the method that the mobile terminal, in particular taking into account the results of the evaluation in accordance with the invention, sends a message to the communication network, wherein the receipt of the message by the communication network causes the communication network not to perform or initiate a change from a radio cell of the first type to a radio cell of the second type.

Another beneficial design of the invention provides that the predefined time interval can be set and/or adjusted, preferentially by the communication network and/or by the mobile terminal. Preferentially, the duration of the predefined time interval is between 10 and 30 seconds, between 5 and 40 seconds, or between 1 and 60 seconds. Preferentially, the predefined time interval is determined in such a way that this time interval is shorter than the time interval required or needed for a change of connection from a radio cell of the first type to a radio cell of the second type.

In accordance with another beneficial design of the method according to the invention, a probable value for entry into the service area of a radio cell of the first type is determined within the scope of evaluation, the determined probable value is compared with a predefined limiting value, and a change of connection to a radio cell of the second type is suppressed if the limiting value is exceeded, in order to enable the mobile terminal to set up a connection with a radio cell of the first type within the predefined time interval. Preferentially, the limiting value can be set and/or adjusted, preferably by the communication network operator.

The suppression of a change of connection preferentially occurs in a radio cell of the second type for another predefined time interval. This time interval can preferentially also be set, preferably for a period between 1 and 90 seconds.

According to the invention, it is preferentially provided that a data connection in a radio cell of the first type provides a greater bandwidth than a data connection in a radio cell of the second type. It is therefore especially desirable to use and maintain a data connection in the service area of a radio cell of the first type.

In accordance with another beneficial design of the invention, the evaluation according to the invention is performed using location-related information items with regard to the service areas of radio cells of the first type, wherein the location-related information items with regard to the service areas of radio cells of the first type preferably comprise information items regarding location-related cell boundaries of the radio cells of the first type. The location-related information items regarding the service areas of radio cells of the first type are preferentially provided, at least partly, by a storage device of the at least one communication network and/or by a storage device of the mobile terminal. In accordance with another beneficial improvement of the invention, information items allocated to the location area of a mobile terminal which information items relate to an entry into the service area of a radio cell of the first type are recorded by the mobile terminal and/or by the at least one communication network as further location-related information items with regard to the service areas of radio cells of the first type. Preferentially, the recorded information items comprise information items allocated to a location area with regard to the signal quality of a radio cell of the first type.

In accordance with another beneficial aspect of the invention, the recorded information items are added to the location-related information items regarding the service areas of radio cells of the first type which information items are provided by the storage device of the at least one communication network and/or by the storage device of the mobile terminal, or already available location-related information items regarding the service area of radio cells of the first type are adjusted, taking the recorded information items into account. Preferentially, modifications in relation to location-related information items regarding the service areas of radio cells of the first type are at least partly automatically taken into account in the evaluation and/or definition of the time interval. It is further proposed that preferentially, at least the location-related information items regarding the service areas of radio cells of the first type are preferentially synchronised between the at least one communication network and the mobile terminal.

In accordance with another beneficial design of the invention, the information items regarding the local position of the mobile terminal comprise at least information items regarding the current local position of the mobile terminal, regarding the current direction into which the mobile terminal is changing its local position, regarding the velocity by which the mobile terminal is changing its local position, and/or past information items with regard to the local position, direction, and/or velocity.

As a particularly beneficial design of the invention, it is provided that the communication network is a mobile radio network, the radio cell of the first type is a radio cell in accordance with a first mobile radio standard, the radio cell of the second type is a radio cell in accordance with a second mobile radio standard, and the mobile terminal is designed for operation both in accordance with the first mobile radio standard and in accordance with the second mobile radio standard.

As a particularly beneficial design variant of the invention, a method for operating a mobile terminal in a cellular mobile radio network with radio cells in accordance with a first mobile radio standard and radio cells in accordance with a second mobile radio standard is proposed, wherein the mobile terminal is present in the service area of a radio cell in accordance with the first mobile radio standard and in the service area of at least one other radio cell in accordance with the second mobile radio standard, the mobile terminal uses the radio cell in accordance with the first mobile radio standard for a data connection and the signal quality in relation to the used radio cell in accordance with the first mobile radio standard necessitates a change of connection to another radio cell during the ongoing data connection, which method is characterised in that a forecasting evaluation with regard to a re-entry into the service area of a radio cell in accordance with the first mobile radio standard within a predefined time interval is performed, and if it is established based on the evaluation that a re-entry into the service area of a radio cell in accordance with the first mobile radio standard will occur within the predefined time interval, a change of connection to a radio cell in accordance with the second mobile radio standard is suppressed, in order to enable the mobile terminal to set up a connection to a radio cell in accordance with the first mobile radio standard within the predefined time interval.

The present invention utilises the realisation that often there are only a few seconds between leaving the service area of a radio cell of the first type, for instance in accordance with a first mobile radio standard, as in particular a UMTS mobile radio standard, and a re-entry into the service area of a radio cell of the first type. To that extent, a data transmission using the method according to the invention will be less delayed in particular if the mobile terminal is present right next to the service area of a radio cell of the first type and the signal quality, for instance due to shadowing of signal reception, necessitates only a short-term change of connection to another radio cell, namely a radio cell of the second type, for instance a radio cell in accordance with the second mobile radio standard. A short interruption of the data connection due to loss of signal in the mobile radio network in accordance with the first mobile radio standard and an almost immediately following re-entry into the service area of a radio cell in accordance with the first mobile radio standard and a corresponding resumption of the data connection in the mobile radio network in accordance with the first mobile radio standard will then, as it has surprisingly turned out, be performed considerably more quickly than the system change from the first mobile radio standard to the second mobile radio standard in connection with a set-up of the data connection in the mobile radio network in accordance with the second mobile radio standard and another system change from the second mobile radio standard back to the first mobile radio standard and a resumption of the data connection in the mobile radio network in accordance with the first mobile radio standard. In accordance with this discovery, this positive effect can be used in a particularly beneficial way if, preferentially by the mobile terminal, a change from a radio cell in accordance with the first mobile radio standard to a radio cell in accordance with the second mobile radio standard is suppressed, i.e. prevented, so that a change to a radio cell in accordance with the second mobile radio standard does not take place.

A particularly preferred further design of the invention provides that the evaluation is performed using location-related information items with regard to the service areas of radio cells in accordance with the first mobile radio standard and using information items about or with regard to the local position of the mobile terminal.

This is based on the further discovery that a decision can be made whether a change from a radio cell in accordance with the first mobile radio standard to a radio cell in accordance with a second mobile radio standard is to be performed or not, and therefore in the latter case whether a change to a radio cell in accordance with the second mobile radio network is to be suppressed, which decision can be made particularly beneficially when taking into account or using the current local position of the mobile terminal, in particular a local position determined by geographical coordinates, and taking into account or using recorded, location-related information items with regard to the service area of other radio cells in accordance with the first mobile radio standard or with regard to the signal quality of signals allocated to a radio cell in accordance with the first mobile radio standard. The use of location-related information items with regard to the service areas of radio cells in accordance with the first mobile radio standard and the use of information items about or with regard to the local position of the mobile terminal preferentially makes it possible to make a decision about whether a change to a radio cell in accordance with a second mobile radio standard is to be performed or suppressed, with a high reliability that any occurring delay period in data transmission will be minimal.

The aforementioned design is also particularly beneficial because the signal quality in relation to the used radio cell in accordance with the first mobile radio standard often necessitates a change of connection to another radio cell during the ongoing data connection when the mobile terminal changes its local position and moves out of the service area of a radio cell in accordance with the first mobile radio standard. To that extent, the present invention is particularly beneficial if a user of a corresponding mobile terminal is on the road with means of transport such as train or car, since due to the relatively high travel speed and the quickly covered distances, a change of connection to another radio cell is frequently required. Preferentially, based on data on location, movement, radio cell change, and/or geographical data as location-related information items with regard to the service areas of radio cells of the first type or in accordance with the first mobile radio standard and as information items with regard to the local position or information items about the local position of the mobile terminal, the method according to the invention makes it possible to predetermine a probable future change of radio cells and to suppress a probable system change from a radio cell of the first type or in accordance with a first mobile radio standard to a radio cell of the second type or in accordance with a second mobile radio standard in order to realise a shorter interruption of a data connection or a shorter delay in data transmission during an ongoing data connection.

According to the invention, location-related information items with regard to the service areas of radio cells in accordance with the first mobile radio standard preferentially comprise information items allocated to geographical coordinates and/or areas defined by geographical coordinates, for instance grid squares, with regard to the signal quality in relation to a use of a radio cell by means of a mobile terminal, in particular to the effect whether in relation to a particular location, it is possible to use a radio cell in accordance with the first mobile radio standard by means of a mobile terminal. Preferentially, corresponding information items are adjusted in dependence on the used mobile terminal, in particular in order to be able to take different transmitting/receiving powers of different mobile terminals into account. According to the invention, it is also provided that the allocation of the information items with regard to the signal quality in relation to a use of a radio cell by means of a mobile terminal is performed as a supplement and/or as an alternative in relation to locations defined by the mobile radio network or by components of the mobile radio network, in particular by base transceiver stations of the mobile radio network (BTS, Node B).

In the method according to the invention, the data connection is preferentially accomplished by means of a package-oriented data service, particularly preferably by means of a package-oriented data service of the mobile radio network. Herein, a disconnection of the data connection, for instance in the mobile radio network in accordance with the first mobile radio standard, upon suppression of a change of connection to a radio cell in accordance with the second mobile radio standard and a following renewed set-up of the data connection upon re-entry into the service area of a radio cell of the mobile radio network in accordance with the first mobile radio standard will preferentially remain almost unnoticed by the user.

In accordance with another beneficial design of the method according to the invention, a probable value for re-entry into the service area of a radio cell in accordance with the first mobile radio standard is determined within the scope of evaluation, the determined probable value is compared with a predefined limiting value, and a change of connection to a radio cell in accordance with the second mobile radio standard is suppressed if the limiting value is exceeded in order to enable the mobile terminal to set up a connection with a radio cell in accordance with the first mobile radio standard within the predefined time interval. Preferentially, the limiting value can be set and/or adjusted, preferably by the mobile radio network operator. Accordingly, it is in particular provided that the mobile radio network operator can set the limiting value higher if the service area of the radio cells in accordance with the first mobile radio standard is reduced due to high capacity utilisation of the same.

Another beneficial design of the method according to the invention is characterised in that the suppression of a change of connection to a radio cell of the second type or in accordance with the second mobile radio standard is realised for a predefined further time interval. If, upon expiry of this predefined further time interval, contrary to the determination based on the evaluation, no re-entry into the service area of a radio cell of the first type or in accordance with the first mobile radio standard has occurred, a change to a radio cell of the second type or in accordance with the second mobile radio standard will preferentially be enabled, so that a resumption of the data connection by means of the mobile terminal will be possible. Such a design is particularly beneficial in the event that a user of a mobile terminal is on the road by car and an uncalculated change of velocity by which the mobile terminal changes its local position is caused for instance by a traffic jam, so that a re-entry of the mobile terminal into the service area of a radio cell of the first type or in accordance with the first mobile radio standard does not occur within the predefined time interval. Preferentially, the further predefined time interval can also be set and/or adjusted, preferably by the user and/or by the mobile radio network operator. In accordance with a preferred setting of a further predefined time interval, the length of a further time interval during which a change of connection to a radio cell in accordance with the second mobile radio standard is suppressed corresponds to the length of the time interval within which a re-entry into the service area of a radio cell in accordance with the first mobile radio standard is supposed to occur. Another beneficial design of the invention provides that before and/or upon expiry of the further predefined time interval, another evaluation according to the invention will be performed, and upon the determination based on the evaluation that a re-entry into the service area of a radio cell of the first type or in accordance with the first mobile radio standard will occur within the predefined time interval, preferably within a time interval which is shorter than the predefined time interval, a renewed suppression of a change of connection to a radio cell of the second type or in accordance with the second mobile radio standard will occur for the predefined further time interval, preferably for a time interval which is shorter than the predefined time interval.

Another beneficial design of the method according to the invention provides that during suppression of the change to a radio cell of the second type or in accordance with the second mobile radio standard measures for a change to a radio cell of the second type or in accordance with the second mobile radio standard will be taken in the background by the mobile terminal, so that in the event that a re-entry into the service area of a radio cell of the first type or in accordance with the first mobile radio standard should not occur, a change to a radio cell of the second type or in accordance with the second mobile radio standard can be realised immediately.

In accordance with a particularly preferred design variant of the method according to the invention, a data connection in accordance with the first mobile radio standard provides a larger bandwidth than a data connection in accordance with the second mobile radio standard. Preferably, the first mobile radio standard corresponds to the UMTS, LTE, or CDMA2000 radio network standard. The second mobile radio standard preferably corresponds to the GSM mobile radio standard.

According to the invention, it is provided that the method according to the invention is at least partly carried out, or can be carried out, by the mobile terminal. It is also provided that the method according to the invention is at least partly carried out or can be carried out by the mobile radio network or by at least one device of the mobile radio network. In particular, it is provided that at least the evaluation according to the invention is carried out or can be carried out both on the part of the mobile terminal and on the part of the mobile radio network, or on the part of at least one device of the mobile radio network.

In accordance with another beneficial design of the invention, the location-related information items with regard to the service areas of other radio cells in accordance with the first mobile radio standard comprise information items with regard to location-related cell boundaries of the radio cells in accordance with the first mobile radio standard. The cell boundaries define the boundaries of the service area of a radio cell, i.e. they comprise the area within which the radio cell can be used by the mobile terminal. Preferentially, the cell boundaries, in particular at the peripheral areas of the radio cell, are adjusted, preferentially on the part of the mobile radio network, in accordance with the actual usability of the radio cell by a mobile terminal operable in a mobile radio network. In a preferred design of the invention, the cell boundaries of the radio cells in accordance with the first mobile radio standard are each defined for different types or different models of mobile terminals, preferentially corresponding to their transmitting and receiving power. Another beneficial design provides that, preferentially on the part of the mobile terminal, the cell boundaries are individually stored for the mobile terminal, at least for defined location areas in the mobile radio network. According to another design variant of the method according to the invention, the cell boundaries, starting from a base transceiver station (RNC, BTS) supplying the radio cell, are modelled geometrically, preferentially with a circular or honeycombed cell boundary. In a simplified circular model of the cell boundaries, the position of the base transceiver station is recorded as the centre of the circle, and the dimension of the range of transmission/reception of the radio cell is recorded as the radius of the circle.

Another design of the invention provides that the location-related information items with regard to the service areas of radio cells in accordance with the first mobile radio standard are provided at least partly by a storage device of the mobile radio network and/or by a storage device of the mobile terminal, e.g. by a database. For the provision on the part of the mobile terminal, at least for selected location areas in the mobile radio network, the information items are transmitted from the mobile radio network to the mobile terminal, using a communication service of the mobile radio network.

According to another design of the present invention, information items allocated to a location area, preferably a location area defined by the peripheral area of a service area of a radio cell of the first type or in accordance with the first mobile radio standard and/or by geographical coordinates, which information items relate to an entry or re-entry into the service area of a radio cell of the first type or in accordance with the first mobile radio standard are recorded by the mobile terminal and/or by the mobile radio network as further location-related information items with regard to the service areas of radio cells of the first type or in accordance with the first mobile radio standard. The recorded information items are preferentially used in order to verify or adjust the defined cell boundaries. Herein, the recorded information items may be recorded as empirical values in an empirical value database and stored together with the location-related information items regarding the service areas of radio cells of the first type or in accordance with the first mobile radio standard. According to a preferred design, the recorded information items comprise information items allocated to a location area with regard to signal quality of a radio cell of the first type or in accordance with the first mobile radio standard. Based on signal qualities allocated to location areas, it is preferentially possible to improve determinations with regard to an entry or re-entry into the service area of a radio cell of the first type or in accordance with the first mobile radio standard. In particular, based on signal qualities allocated to location areas and/or based on information items regarding the location area of the mobile terminal, it is possible to determine or forecast distances to be covered for an entry or re-entry into the service area of a radio cell of the first type or in accordance with the first mobile radio standard. Taking account of the velocity by which the mobile terminal is moving, it can be preferentially determined within the scope of evaluation within which period of time a re-entry into the service area of a radio cell of the first type or in accordance with the first mobile radio standard will occur or is probable, and whether this period is within the predefined time interval. In this context, velocity is a vectorial value which indicates a direction of movement of the mobile terminal as the difference between two position vectors on the one hand and a velocity magnitude of the moving mobile terminal in the direction of movement, on the other hand. To that extent, the velocity of the mobile terminal also comprises an information item regarding the local position of the mobile terminal, for instance in a service area of a radio cell.

Furthermore, it is provided according to the invention that the recorded information items which are provided by the storage device of the mobile radio network and/or by the storage device of the mobile terminal are added to the location-related information items regarding the service areas of radio cells of the first type or in accordance with the first mobile radio standard or that already existing location-related information items with regard to the service area of other radio cells of the first type or in accordance with the first mobile radio standard are adjusted, taking the recorded information items into account. Preferentially, modifications in relation to location-related information items with regard to the service areas of radio cells of the first type or in accordance with the first mobile radio standard are at least partly automatically taken into account with the evaluation and/or definition of the time interval within which an entry or re-entry into the service area of the radio cell of the first type or in accordance with the first mobile radio standard is to take place. In this manner, it is preferentially possible to realise a further optimisation with regard to a reduction of delay periods in a data transmission. In accordance with a preferred design, the method according to the invention uses a so-called self-learning system for this optimisation. In another beneficial design, an optimisation of the method according to the invention is provided by automatic reporting by a multitude of users (“cloud reporting”).

In accordance with another beneficial design of the invention, at least the location-related information items with regard to the service areas of radio cells in accordance with the first mobile radio standard are synchronised between the mobile radio network and the mobile terminal. Preferentially, the corresponding information items will be kept up-to-date in this way and can be used for a further improvement and optimisation of the method.

A particularly preferred design of the invention provides that the information items regarding the local position, or of the local position of the mobile terminal, comprise at least information items regarding the current local position of the mobile terminal, with regard to the current direction into which the mobile terminal is changing its local position, with regard to the current velocity by which the mobile terminal is changing its local position, and/or past information items with regard to local position, direction, and/or velocity. In accordance with a beneficial design of the method according to the invention, the information items regarding the local position of the mobile terminal are determined using satellite-based position determination, preferably GPS (GPS: Global Positioning System), cell of origin positioning on the part of the mobile radio network, a combination of satellite-based position determination and cell of origin positioning on the part of the mobile radio network, preferentially A-GPS (A-GPS: Assisted Global Positioning System), and/or by so-called WLAN scans (WLAN: Wireless Local Area Network). In accordance with another beneficial design of the invention, the information items regarding the local position of the mobile terminal are determined by the mobile radio network by evaluating the changes of radio cells. Preferentially, this design variant of the invention can also be used by mobile terminals which do not have any means to determine the local position.

In another beneficial design of the method according to the invention, geographical information and/or information relating to the traffic structure are taken into account in the evaluation, in particular courses of roads, and e.g. directions of traffic predetermined by one-way streets, train routes, rivers, and similar information. Preferentially, the evaluations regarding the occurrence of a re-entry into the service area of a radio cell of the first type or in accordance with the first mobile radio standard within a predefined time interval can be further improved if, in addition to the information on the local position of the mobile terminal, geographical information and/or information regarding the traffic infrastructure is taken into account, since—in particular with additional consideration of courses of roads—it is easier to determine how much time will pass until a re-entry into the service area of a radio cell of the first type or in accordance with the first mobile radio standard will take place, in particular if a further course of a road deviates from a current direction of movement in which the mobile terminal is changing its local position. According to the invention, it can preferentially be set on the mobile terminal, in particular activated or deactivated, that geographical information and/or information relating to the traffic infrastructure is taken into account.

Another beneficial design of the invention provides that at least within the scope of evaluation of location-related information items regarding the service areas of radio cells in accordance with the first mobile radio standard, the transmitting and/or receiving power of the mobile terminal and/or the transmitting and/or receiving powers of the base transceiver station (BTS, Node-B) of radio cells are taken into account.

Even if it is preferably provided that the mobile terminal initiates the change of connection to another radio cell, additional embodiments are provided in which the mobile radio network, preferentially a network element of the mobile radio network, in particular a radio network controller (RNC) of a UMTS mobile radio network or a base station controller (BSC) of a GSM mobile radio network, initiates the change of connection to another radio cell. Such embodiments are to be preferred in particular if the location-related information items regarding the service areas of radio cells in accordance with the first mobile radio standard are updated at very short time intervals, in particular at time intervals of a few seconds up to time intervals of several minutes, and a use of the most current information items is intended. In these cases, the data traffic would in fact sometimes be strongly increased by the transmission of corresponding information items to the mobile terminal. Furthermore, embodiments where a change of connection to another radio cell is initiated by the mobile radio network or by a network element of the mobile radio network are beneficial in particular if the method according to the invention is to be used with minor variations by a first mobile radio network operator in order to suppress a change from a radio cell operated by the first mobile radio network operator to a radio cell operated by a second mobile radio network operator, in the event that the mobile terminal is able to re-establish a connection to a radio cell operated by the first mobile radio network operator within a predefined time interval. In such an embodiment, a radio cell in accordance with a first mobile radio standard would be a radio cell operated by a first mobile radio network operator, and the second radio cell in accordance with a second mobile radio standard would be a radio cell operated by a second mobile radio network operator, wherein the first mobile radio standard and the second mobile radio standard may be identical mobile radio standards. To that extent, the present invention additionally relates to a method for operating a mobile terminal in a cellular mobile radio network with radio cells operated by a first mobile radio network operator and radio cells operated by a second mobile radio network operator, wherein the mobile terminal is designed for operation both in the radio cells of the first mobile radio network operator and in the radio cells of the second mobile radio network operator, the mobile terminal changes its local position in the mobile radio network, the mobile terminal is present in the service area of a radio cell operated by a first mobile radio network operator and in the service area of at least one further radio cell operated by a second mobile radio network operator, the mobile terminal uses the radio cell operated by the first mobile radio network operator for a data connection, and the signal quality in relation to the used radio cell necessitates a change of connection to another radio cell during the ongoing data connection, characterised in that, using location-related information items regarding the service areas of other radio cells operated by the first mobile radio network operator and using information items regarding the local position of the mobile terminal, an evaluation regarding the occurrence of a re-entry into a radio cell operated by the first mobile radio network operator within a predefined time interval is performed and, upon the determination based on the evaluation that a re-entry into the service area of a radio cell operated by the first mobile radio network operator will occur within the predefined time interval, a change of connection to a radio cell operated by the second mobile radio network operator is suppressed in order to enable the mobile terminal to set up a connection to a radio cell operated by the first mobile radio network operator within the predefined time interval. Beneficial design variants of this method result from a combination of features described in the present patent application.

In accordance with another aspect of the present invention, a computer program product is provided which is preferentially stored on a mobile terminal operable in a communication network or in a mobile radio network and which is configured to perform at least one of the proposed methods according to the invention. Preferentially, the computer program product is in particular designed to manipulate or control the components of a device on which the computer program product is stored in such a way that with operation of a mobile terminal in a cellular mobile radio network with radio cells in accordance with a first mobile radio standard and radio cells in accordance with a second mobile radio standard, wherein the mobile terminal is configured for operation both in accordance with the first mobile radio standard and in accordance with the second mobile radio standard, the mobile terminal changes its local position in the mobile radio network, the mobile terminal is present in the service area of a radio cell in accordance with the first mobile radio standard and in the service area of at least one other radio cell in accordance with the second mobile radio standard, the mobile terminal uses the radio cell in accordance with the first mobile radio standard for a data connection, and the signal quality in relation to the used radio cell in accordance with the first mobile radio standard necessitates a change of connection to another radio cell during the ongoing data connection, an evaluation regarding a re-entry of a mobile terminal into the service area of a radio cell in accordance with a first mobile radio standard within a predefined time interval is performed, based on the evaluation it is determined after which time interval a re-entry of the mobile terminal into the service area of a radio cell in accordance with the first mobile radio standard will take place, the time interval is compared to a predefined time interval, upon determination that the time interval is shorter than or equal to the predefined time interval, a change of connection of the mobile terminal to a radio cell in accordance with the second mobile radio standard is suppressed, and upon re-entry of the mobile terminal into the service area of a radio cell in accordance with the first mobile radio standard within the predefined time interval, a set-up of a connection to that radio cell is initiated.

In order to solve the task mentioned in the beginning, the present invention also suggests a mobile terminal for operation in at least one communication network, preferably a mobile radio network, wherein radio cells of a first type and radio cells of a second type are formed by the at least one communication network, which comprises means for carrying out at least one of the methods proposed by the present invention. The terminal is preferentially designed to be operated in a mobile radio network in accordance with a first mobile radio standard and/or in at least one other mobile radio network in accordance with another mobile radio standard, in particular a mobile radio network in accordance with a UMTS, LTE, and/or GSM radio network standard. Furthermore, the mobile terminal is preferentially adapted for operation in a WLAN.

It is in particular provided that a beneficial design of the mobile terminal comprises means for satellite-based position determination and/or navigation, preferably means for utilisation of the global positioning system (GPS), such as in particular a GPS receiver.

According to another beneficial design, it is further provided that the mobile terminal comprises a storage device for storing location-related information items regarding the service areas of radio cells in accordance with the first mobile radio standard, preferably a flash memory.

According to the invention, it is further provided that the mobile terminal preferentially has an evaluation unit which is preferentially configured and/or set up to perform an evaluation regarding a re-entry of the mobile terminal into the service area of a radio cell in accordance with a first mobile radio standard occurring within a predefined time interval, to determine based on the evaluation after what time interval a re-entry of the mobile terminal into the service area of a radio cell in accordance with the first mobile radio standard will occur, to compare the time interval with a predefined time interval, to suppress—upon determination that the time interval is shorter than or equal to the predefined time interval—a change of connection of the mobile terminal to a radio cell in accordance with the second mobile radio standard and, upon re-entry of the mobile terminal into the service area of a radio cell in accordance with the first mobile radio standard within the predefined time interval, to initiate a set-up of a connection to this radio cell. The evaluation unit is preferably a processor. The latter can in particular be adapted to control essential functionalities of the mobile terminal.

According to the invention, it is provided that the mobile terminal is in particular a mobile telephone, preferably a smart phone, or a data card, preferably a so-called surf stick which, with the aid of a mobile radio subscriber identification module, preferentially a SIM card (SIM: Subscriber Identity Module), can establish a communication connection via a mobile radio network. According to the invention, the mobile terminal may preferentially also be a device which is connected via an interface to a unit designed for establishing a communication connection via a mobile radio network. Such a device may, preferably in combination with a navigation system, preferentially be provided in a motor car, wherein the device is preferentially connected to a mobile telephone via a radio interface, preferably a bluetooth interface, or a serial bus, preferably a USB interface.

The mobile terminal preferentially comprises an evaluation unit for evaluating an information item regarding the local position of the mobile terminal in a service area of a radio cell of the first type with regard to an entry of the mobile terminal into the service area of a radio cell of the first type, which entry is to be expected within a predefined time interval. The mobile terminal further preferentially comprises a suppression unit for suppressing a change of connection of the mobile terminal to a radio cell of the second type.

For the solution of the task mentioned in the beginning, the present invention also suggests a device in a communication network, preferably a network node in a mobile radio network, wherein the communication network or the mobile radio network and/or at least one further communication network form radio cells of a first type and radio cells of a second type, which comprises means for carrying out at least one of the methods suggested by the present invention. The mobile radio network is preferably configured in accordance with a UMTS, LTE, or GSM radio network standard.

The device preferentially comprise an evaluation unit for evaluating an information item regarding the local position of the mobile terminal in a service area of a radio cell of the first type with regard to an entry of the mobile terminal into the service area of a radio cell of the first type, which entry is to be expected within a predefined time interval. The device further preferentially comprises a suppression unit for suppressing a change of connection of the mobile terminal to a radio cell of the second type.

The evaluation unit of the device is preferably configured and/or set up to perform an evaluation with regard to a re-entry of a mobile terminal, preferably of a mobile terminal according to the invention, into the service area of a radio cell of the first type or in accordance with a first mobile radio standard occurring within a predefined time interval, to determine based on the evaluation after what time interval a re-entry of the mobile terminal into the service area of a radio cell of the first type or in accordance with the first mobile radio standard will occur, to compare the time interval with a predefined time interval, to suppress—upon determination that the time interval is shorter than or equal to the predefined time interval—a change of connection of the mobile terminal to a radio cell of the second type or in accordance with the second mobile radio standard, and to send a command to another device of the mobile radio network, preferentially to a device of the mobile radio network involved in a handover, which command will cause the corresponding device to suppress a change of connection of the mobile terminal to a radio cell of the second type or in accordance with the second mobile radio standard. According to another beneficial design, the device according to the invention is also designed and/or set up to initiate, upon re-entry of the mobile terminal into the service area of a radio cell of the first type or in accordance with the first mobile radio standard within the predefined time interval, a set-up of a connection between the mobile terminal and this radio cell.

Preferentially, the device according to the invention is designed to exchange data with other devices of the mobile radio network for the purpose of executing the method according to the invention or within the scope of execution of the method according to the invention. These data preferentially refer to location-related information items according to the invention with regard to the service areas of radio cells of the first type or in accordance with a first mobile radio standard, information items with regard to the local position of the mobile terminal, and/or information items with regard to the execution of a hand-over.

According to another beneficial design of the device according to the invention, it is provided that the device comprises a storage device for storing location-related information items with regard to the service areas of radio cells in accordance with the first mobile radio standard. Preferentially, the storage device is a database or structured in the form of a database.

For the solution of the task mentioned in the beginning, the present invention further suggests a system comprising at least one device of a communication network, preferentially a network node of a mobile radio network, and a mobile terminal for operation in a communication network, in particular in a mobile radio network, wherein the at least one device of the mobile radio network and the mobile terminal are configured to exchange information with each other, wherein the system is adapted to execute at least one of the methods proposed by the present invention. For this purpose, the mobile terminal preferentially comprises means which enable at least partly the execution of a proposed method according to the invention, and the device of the mobile radio network comprises means which enable at least partly the execution of a proposed method according to the invention, so that by a corresponding exchange of information between the mobile terminal and the device of the mobile radio network, a proposed method according to the invention can be executed. In a beneficial design of the system, the mobile terminal is at least partly designed like the terminal according to the invention. In another beneficial design of the system, the device of the mobile radio network is at least partly designed like the device of the mobile radio network according to the invention.

### BRIEF DESCRIPTION OF THE DRAWINGS

Further beneficial details, characteristics and designs of the invention are explained in the following in more detail based on the exemplary embodiments shown in the figures of the drawing. In these figures:

FIG. 1 shows a schematic diagram of a change of connection known in the state of the art from a radio cell in accordance with a first mobile radio standard to another radio cell of the same mobile radio standard;

FIG. 2 shows a schematic diagram of a change of connection known in the state of the art from a radio cell in accordance with a first mobile radio standard to a radio cell in accordance with a second mobile radio standard, and another change from the radio cell in accordance with the second mobile radio standard to a radio cell in accordance with the first mobile radio standard;

FIG. 3 shows a schematic diagram of an embodiment of a method according to the invention, in particular the suppression of a change from one radio cell in accordance with a first mobile radio standard to a radio cell in accordance with a second mobile radio standard occurring within the scope of the method according to the invention, and a resumption of a data connection in a radio cell in accordance with the first mobile radio standard;

FIG. 4 shows a schematic diagram of an evaluation performed in connection with the execution of a method according to the invention with regard to a re-entry into the service area of a radio cell in accordance with the first mobile radio standard occurring within a predefined time interval using location-related information items with regard to the service areas of radio cells in accordance with the first mobile radio standard and using information items with regard to the local position of the mobile terminal;

FIG. 5 shows a schematic diagram of another evaluation performed in connection with the execution of a method according to the invention with regard to a re-entry into the service area of a radio cell in accordance with the first mobile radio standard occurring within a predefined time interval using location-related information items with regard to the service areas of radio cells in accordance with the first mobile radio standard and using information items with regard to the local position of the mobile terminal;

FIG. 6 shows a schematic representation of a radio cell of a mobile radio network with variably defined cell boundaries;

FIG. 7 shows a schematic representation of another radio cell of a mobile radio network with variably defined cell boundaries;

FIG. 8 shows a flow diagram of an exemplary embodiment of a method according to the invention;

FIG. 9 shows a simplified schematic diagram of an exemplary embodiment of a mobile terminal according to the invention;

FIG. 10 shows a simplified schematic diagram of an exemplary embodiment of a device of a mobile radio network according to the invention;

FIG. 11a shows a simplified schematic representation of a design variant of the invention;

FIG. 11b shows a simplified schematic representation of another design variant of the invention;

FIG. 11c shows a simplified schematic representation of another design variant of the invention;

FIG. 11d shows a simplified schematic representation of another design variant of the invention;

FIG. 12 shows a schematic diagram of another exemplary embodiment of a method according to the invention; and

FIG. 13 shows a flow diagram of another exemplary embodiment of a method according to the invention.

### DETAILED DESCRIPTION

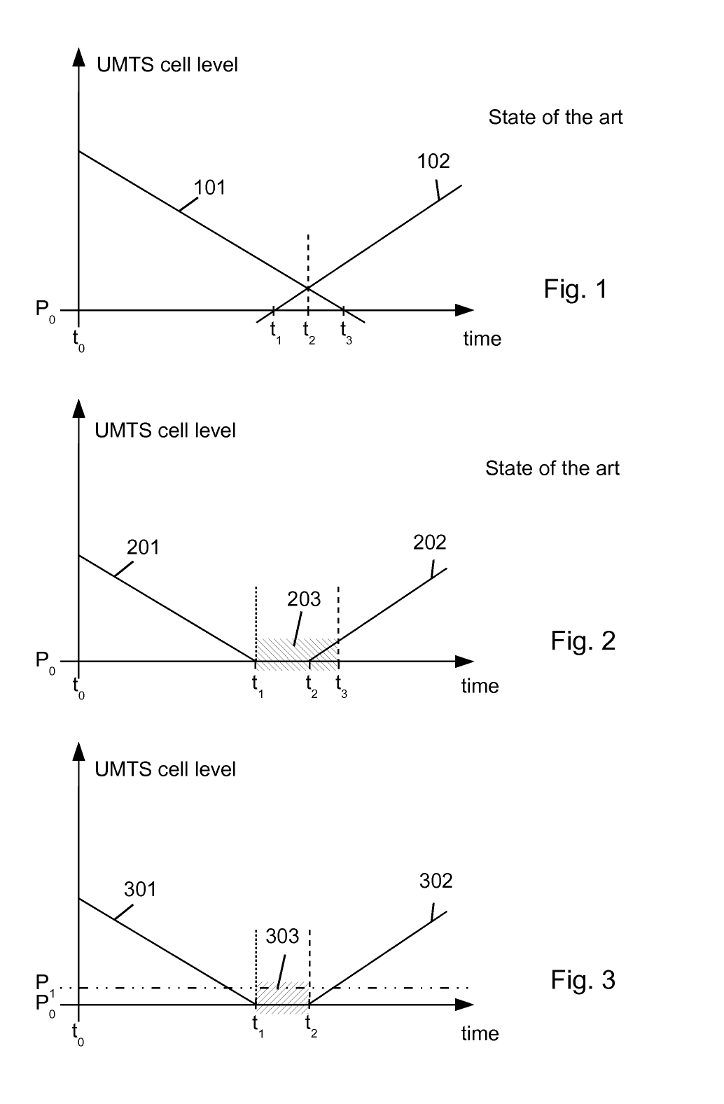

FIG. 1 shows a schematic diagram of a change of connection known in the state of the art of a mobile telephone changing its local position in a mobile radio network during a data transmission from one radio cell (not shown in FIG. 1) of the mobile radio network, in the present case a mobile radio network in accordance with the UMTS mobile radio standard, to another radio cell of the mobile radio network (UMTS). In addition, a cell level 101 of a first radio cell of the mobile radio network, which level is changing in time due to the change of the local position of the mobile telephone, and a second cell level 102 of a second radio cell of the mobile radio network which level is changing in time are shown in a simplified manner as a function of time in a coordinate system. Cell level P₀ represents the value of the cell level which is not sufficient any more for use by means of the mobile telephone. That means that when a cell level P₀ of a used radio cell is approached, the signal quality in relation to the used radio cell during an ongoing data connection necessitates a change of connection to another radio cell.

In FIG. 1, the mobile telephone is initially, i.e. for a period smaller than t₂, using the radio cell with cell level 101. In doing so, the mobile telephone measures the currently receivable cell level for a period smaller than t₁, i.e. cell level 101. Starting from time instant t₁, the mobile telephone will receive also cell level 102 of the second radio cell in addition to cell level 101 of the first radio cell. Depending on the strength of the respective cell level it is then decided which radio cell is to be used by the mobile telephone. Since cell level 102, as shown in FIG. 1, will be stronger than cell level 101 starting from a time instant t₂, in FIG. 1 symbolised by a dashed line, a change from the first radio cell with cell level 101 to the second radio cell with cell level 102 will be initiated, although the signal or the cell level 101 of the first radio cell can still be received by the mobile telephone until time instant t₃. During the change or handover from the first radio cell to the second radio cell, the data connection will be maintained, i.e. there will be no interruption in data transmission.

Often, however, it is the case that during an ongoing data connection, the signal quality, or the cell level of a first radio cell in accordance with a first mobile radio standard receivable by a mobile telephone, necessitates a change to another radio cell, while the signal quality or the cell level of other radio cells in accordance with the first mobile radio standard, however, is not sufficient at that time to be used for the data connection by the mobile telephone. If at that time, the mobile telephone is present in the service area of another radio cell in accordance with a second mobile radio standard, the current state of the art provides for a change of connection to the radio cell in accordance with the second mobile radio standard. Such a change of connection during an ongoing data connection of a mobile telephone changing its local position is shown in a simplified schematic diagram in FIG. 2.

As in FIG. 1, a simplified representation of a cell level 201 of a first radio cell of the mobile radio network, which cell level is changing in time due to the change of the local position of the mobile telephone, and a cell level 202 of a second radio cell of a mobile radio network in accordance with a first mobile radio standard, in the present case a UMTS mobile radio standard, which cell level is changing in time, is shown also in FIG. 2 as a function of time in a coordinate system. Herein, cell level P₀ represents the value of the cell level which is not sufficient any more for use by means of the mobile telephone.

In FIG. 2, the mobile telephone initially uses a first radio cell of the UMTS mobile radio network with a cell level 201 for a data connection and in addition is present in a service area not shown in FIG. 2 of at least one other radio cell in accordance with a second mobile radio standard, in the present case a GSM mobile radio standard. Since cell level 201, and therefore the signal quality of the first radio cell in accordance with the UMTS mobile radio standard, decreases with time, the signal quality necessitates a change of connection to another radio cell in relation to the used radio cell in accordance with the UMTS mobile radio standard during the ongoing data connection. Since cell level 202 of the second radio cell in accordance with the UMTS mobile radio standard, however, is also below cell level P₀ until time instant t₁ (symbolised by a small-dotted line in FIG. 2) when the cell level reaches or falls below the value P₀, the mobile telephone cannot change to a radio cell in accordance with the UMTS mobile radio standard. Instead, the mobile telephone will be switched to GSM operation. A corresponding system change from UMTS to GSM will be initiated from time instant t₁. In this process, the ongoing data connection using the UMTS radio cell will be interrupted, and then resumed when the change to a radio cell in accordance with the GSM mobile radio standard has been accomplished. If then, as shown in FIG. 2, a signal or a cell level 202 of a radio cell in accordance with a UMTS mobile radio standard with a cell level that exceeds the cell level P₀ by a certain threshold value can be received by the mobile telephone starting from time instant t₃ (symbolised by the dashed line in FIG. 2), the data connection will again be interrupted, a change of connection from the GSM radio cell to the UMTS radio cell will be performed, and the data connection will be resumed after the change to the UMTS radio cell with cell level 202 has been accomplished. That means that between the time instants t₁ and t₃ (this time span is marked by hatching in FIG. 2), the mobile telephone does not use the UMTS mobile radio network, and to that extent, the data transmission is clearly worse and strongly delayed during that period in comparison with the prior use of the UMTS radio cell. This can be attributed in particular to the fact that within the time span 203, during the system change from the UMTS radio cell to the GSM radio cell, a system-related interruption of the data connection of usually about 15 to 20 seconds will occur. The repeated system change from the GSM mobile radio cell to the UMTS mobile radio cell after reception of a usable UMTS cell level by means of the mobile telephone will lead to another interruption of the data connection of approx. 4 to 7 seconds. Accordingly, the data connection of the mobile telephone will be interrupted for an overall period of about 20 to 30 seconds, which will considerably delay data transmission. Another delay of data transmission results from the slower data rate in the GSM radio cell which, even when using a refined GPRS data service, is usually clearly below the data rate of data services of UMTS mobile radio networks.

FIG. 3 shows a simplified representation of a cell level 301 of a first radio cell in accordance with a first mobile radio standard, presently a UMTS mobile radio standard, which cell level is changing in time due to a change of the local position of a mobile terminal using a data connection in a mobile radio network, and a cell level 302 of a second radio cell in accordance with the UMTS mobile radio standard correspondingly changing in time, as a function of time in a coordinate system. Cell level P₀ is the value of the cell level which is not sufficient any more for use by means of the mobile telephone. Herein, the mobile terminal is designed both for operation in the UMTS mobile radio network and for operation in a GSM mobile radio network. In the period between the time instants t₀ and t₁, the mobile terminal is present in the service area of a radio cell of the UMTS mobile radio network with cell level 301, which radio cell is used by the mobile terminal for the data connection, in the present case a package-oriented data connection. Moreover, during the entire shown time range, the mobile terminal is present in the service area of at least one other radio cell in accordance with another mobile radio standard, presently a GSM mobile radio standard, which radio cell is not shown in FIG. 3. Due to the decreasing UMTS cell level 301 during the ongoing data connection, the signal quality in relation to the used radio cell of the UMTS mobile radio standard necessitates a change of connection to another radio cell. Since cell level 302 of the other radio cell in accordance with the UMTS mobile radio standard is still below the value P₀ at time instant t₁ (represented by the small-dotted line in FIG. 3) and can therefore not be used yet by the mobile terminal, only a change to the radio cell in accordance with the GSM mobile radio standard, as described in relation to FIG. 2, would be possible.

When the signal quality in relation to the used radio cell in accordance with the first mobile radio standard necessitates a change of connection to another radio cell during the ongoing data connection, it is preferentially provided by the present invention, in contrast to the process flow described in relation to FIG. 2, that an evaluation with regard to a re-entry into the service area of a radio cell in accordance with the UMTS mobile radio standard within a predefined time interval is performed, and upon the determination based on the evaluation that a re-entry into the service area of a radio cell in accordance with the UMTS mobile radio standard will take place within the predefined time interval, a change of connection to a radio cell in accordance with the GSM mobile radio standard will be suppressed in order to enable the mobile terminal to set up a connection to a radio cell in accordance with the first mobile radio standard within the predefined time interval. Herein, the predefined time interval is longer than the time interval [t₁, t₂] 303, which is marked by hatching in FIG. 3 and in the present case is 15 seconds. The evaluation preferentially begins when the UMTS cell level falls below a defined value P₁, which is represented by the dot-and-dash line in FIG. 3. This value can preferentially be set on the part of the mobile terminal and/or on the part of the mobile radio network. Within the time interval during which a set-up of a connection to a radio cell in accordance with the GSM mobile radio standard is suppressed, a connection to the radio cell of the UMTS mobile radio network with cell level 302 will be set up at the time instant t₂, as shown in FIG. 3, and the data connection is continued. During the time interval [t₁, t₂] 303, the connection between the mobile radio network and the mobile terminal will be interrupted. This short interruption of only a few seconds, for instance 5 seconds, preferentially leads to less delays in data transmission than a change to a radio cell in accordance with the GSM mobile radio standard described in relation to FIG. 2, which results in a system-related interruption of the data connection of usually at least 15 seconds.

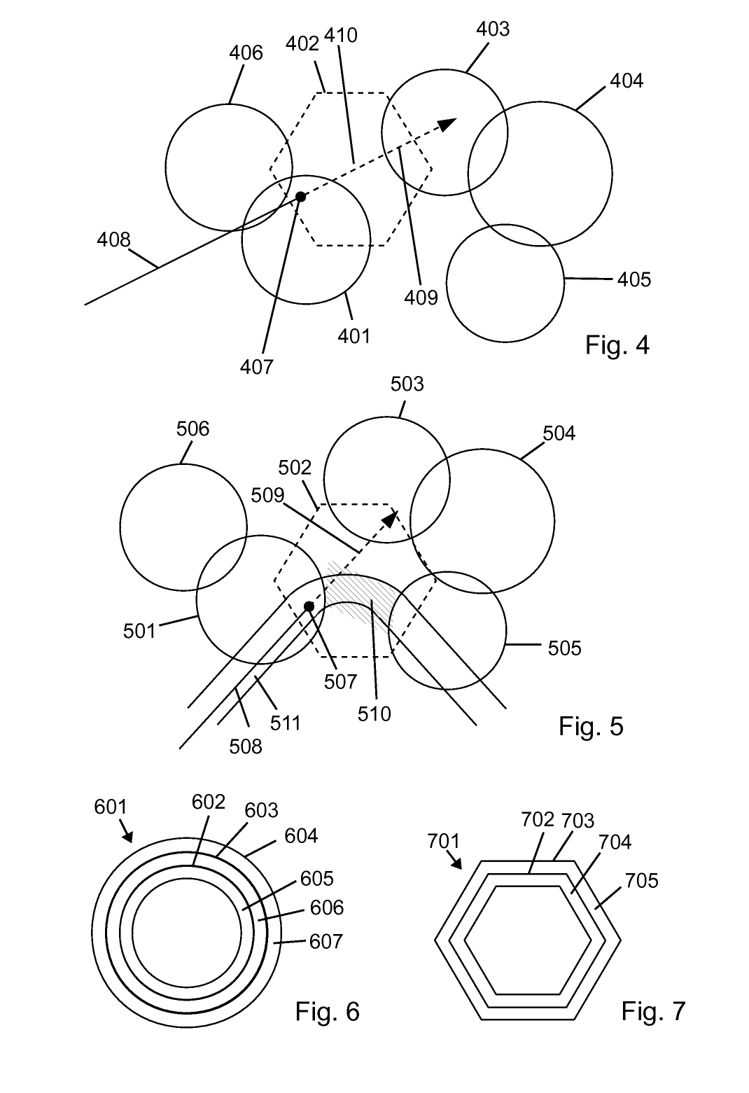

Another particularly beneficial design variant of the method according to the invention is explained with reference to FIG. 4 and FIG. 5. Each of FIG. 4 and FIG. 5 shows a schematic diagram of radio cells in accordance with a UMTS mobile radio standard 401, 403, 404, 405, 406 and 501, 503, 504, 505, 506, and a radio cell 402 and 502 each in accordance with a GSM mobile radio standard. The representation is restricted to one radio cell each in accordance with the GSM mobile radio standard for reasons of greater clarity. In particular, also blanket coverage with radio cells in accordance with a GSM mobile radio standard can be used as a basis. Likewise, the varying representation of the radio cells of the UMTS mobile radio network as circular cells and of the radio cells of the GSM mobile radio network as honeycombed cells was chosen for better distinguishability of the radio cells belonging to different mobile radio standards and is not restrictive. The boundaries of the radio cells marked by the lines in FIG. 4 and FIG. 5 constitute the cell boundaries outside of which the signals of the respective radio cell cannot be used any more for a data connection by means of a mobile terminal operable in a mobile radio network.

According to the invention, a mobile terminal designed both for operation in accordance with the UMTS mobile radio standard and for operation in accordance with the GSM mobile radio standard changes its local position during an ongoing data connection, for instance for transmission of multimedia data. In relation to FIG. 4, a change of the local position of the mobile terminal is taken as a basis, because the user of the mobile terminal is travelling by train. In relation to FIG. 5, a change of the local position of the mobile terminal is taken as a basis, because the user of the mobile terminal is travelling by car on a road 511. The respective current local position 407 or 507 of the mobile terminal is marked by a dot. Both in FIG. 4 and in FIG. 5, the mobile terminal is present in the service area of a radio cell 401 or 501 of the UMTS mobile radio network, which radio cell it uses for the data connection. In the service area of a radio cell, the mobile terminal can use the signals of the radio cell for the data connection. Furthermore, the mobile terminal is present at the local position 407 or 507 in the service area of a radio cell 402 or 502 in accordance with the GSM mobile radio network. Since the mobile terminal is present at the respective local position 407 or 507 near the cell boundary of the respective radio cell 401 or 501, the signal quality, in particular with regard to the level of the used signal of the respective cell (cell level) decreasing towards the cell boundaries, necessitates a change of connection to another radio cell in relation to the used radio cell 401 or 501. A determination when the signal quality necessitates a change of connection to another radio cell may for instance be performed in the manner described in connection with FIG. 6 and FIG. 7.

Since the mobile terminal at the respective local position 407 or 507 is present only in the service are of the respective radio cell 401 or 501, and not in the service area of another radio cell of the UMTS mobile radio network, a change to another radio cell of the UMTS mobile radio network is not possible. As shown in FIG. 4 and FIG. 5, however, other radio cells 403, 404, 405, 406 or 503, 504, 505, 506 in accordance with the UMTS mobile radio standard are present near radio cell 401 or 501. The disadvantage of a change from the UMTS radio cell 401 or 501 to the GSM radio cell 402 or 502 described with reference to FIG. 2 is avoided according to the invention in the way that, using location-related cell boundaries (in FIG. 4 and FIG. 5 shown in an idealised manner as circles) as location-related information items with regard to the service areas of radio cells in accordance with the UMTS mobile radio standard and using information items with regard to the local position of the mobile terminal, an evaluation regarding a re-entry into the service area of a radio cell in accordance with the UMTS mobile radio standard is performed within a time interval of 20 seconds predefined by the mobile radio network operator. The information items regarding the local position which, in the present case, are determined by means of A-GPS (A-GPS: Assisted Global Positioning System) using the mobile terminal, comprise the current local position 407 or 507, information items about the distance 408 or 508 to the current local position which the mobile terminal has covered within a time interval (in FIG. 4 and FIG. 5 shown by a solid black line), the direction 409 or 509, in which the mobile terminal is currently moving (in FIG. 4 and FIG. 5 represented by a dashed arrow), and the velocity by which the mobile terminal is moving or by which the mobile terminal is changing its local position.

In the evaluation shown in FIG. 4 in connection with the execution of the method according to the invention it is determined, based on the aforementioned information items in relation to the local position of the mobile terminal and using the information items regarding the location-related cell boundaries of the radio cells of the UMTS mobile radio network, that the radio cell 403 in accordance with the UMTS mobile radio standard is that radio cell of the UMTS mobile radio network which will be reached next by the mobile terminal.

In a particularly beneficial design of the method according to the invention, other information items relating to the surroundings of the mobile terminal, in particular geographical information items and information items regarding the traffic infrastructure, are evaluated in addition to the above-mentioned information items. Accordingly, in the evaluation according to the invention shown in FIG. 5, the course of the road 511 is taken into account, which leads to the result that not radio cell 503 is determined as the next radio cell of the UMTS mobile radio network, but radio cell 505. Preferentially, it can be set by the mobile terminal whether corresponding ambient information items, such as geographical information items and/or information items about the traffic infrastructure, are to be taken into account in the evaluation. In accordance with another beneficial design, profiles selectable by the user are provided by the mobile terminal, by the selection of which the user can preferentially indicate by what kind of transport means he is travelling. Preferentially, parameters according to the invention, preferentially the threshold value of the signal level P₁ described in connection with FIG. 3 and/or the length of the predefined time interval within which a re-entry into the service area of a radio cell in accordance with the same mobile radio standard is to take place, are adjusted in dependence on the selected profile. In addition, an automatically occurring profile selection on the part of the mobile terminal is preferentially provided, which occurs by evaluation of the information items regarding the local position of the mobile terminal, preferably the velocity by which the mobile terminal is changing its local position.

If a radio cell 403 or 503 has been determined as the next radio cell, i.e. quasi as a target cell, the time within which an entry into the radio cell 403 or 503 of the UMTS mobile radio network determined for further use will occur will be determined in accordance with the invention in the design variants of the invention explained in connection with FIG. 4 and FIG. 5, taking account of the velocity by which the mobile terminal is moving. In another process step of the method according to the invention, it is verified whether the determined time is within the predefined time interval of 20 seconds, i.e. whether it is shorter than 20 seconds, or is maximally 20 seconds. In the design variants shown in FIG. 4 and FIG. 5, the time determined for a probable re-entry into a radio cell in accordance with the UMTS mobile radio standard is less than 20 seconds, so that a change of connection to radio cell 402 or 502 in accordance with the GSM mobile radio standard will be suppressed. After having left radio cell 401 or 501, in a location area 410 or 510 marked by hatching, the mobile terminal will then not be connected with the mobile radio network, so that the data connection will be shortly interrupted. As soon as the mobile terminal enters the service area of radio cell 403 or 503 of the UMTS mobile radio network, the data connection will be resumed.

Each of FIG. 6 and FIG. 7 shows a radio cell 601 or 701 of a mobile radio network in a strongly simplified manner. In accordance with another beneficial design aspect in relation to the method according to the invention, the cell boundaries of the radio cells 601 or 701 are defined differently with regard to their spatial dimensions for different mobile terminals operable in a mobile radio network in dependence on the transmitting and/or receiving power of the different mobile terminals. So for instance the radio cell 601 has the cell boundary 602 for a group of mobile terminals A with comparable transmitting and/or receiving powers. In relation to a second group B of mobile terminals, the cell boundary 603 has been defined, and for mobile terminals of type C, which in the present case have the highest transmitting and/or receiving power, cell boundary 604 has been defined. In relation to radio cell 701 shown in FIG. 7, the cell boundary 702 applies to mobile terminals which, due to almost identical transmitting and/or receiving powers, are allocated to a group D. Cell boundary 703 applies to another group E of mobile terminals which have a higher transmitting and/or receiving power than the mobile terminals of group D. Due to this customisation of cell boundaries, a more precise estimation with regard to the time period until re-entry can preferentially be realised within the scope of the evaluation according to the invention regarding a re-entry into a radio cell in accordance with a first mobile radio standard.

Furthermore, in accordance with another beneficial design aspect of the present invention, areas 605, 606, and 607 or 704 and 705 are marked by varied hatchings in FIGS. 6 and 7. Each of these areas is allocated to the mobile terminals or the group of mobile terminals to which the correspondingly defined cell boundary limiting this area applies. In the respective areas 605, 606, and 607 or 704 and 705, the signal level of a radio cell falls below a predefined value, so that upon entry of the mobile terminal into this area, the signal quality in relation to the radio cell 601 or 701 used by a mobile terminal necessitates a change to another radio cell or at least makes it appear necessary, and an evaluation according to the invention with regard to a re-entry into the service area of a radio cell in accordance with the same mobile radio standard is initiated.

The cell boundaries 603, 604, 605 or 702, 703 and the areas 605, 606, 607 or 704, 705 shown in FIG. 6 and FIG. 7 are presently represented in an idealised strictly geometrical manner. In reality, the cell boundaries and/or areas may deviate from this idealised geometrical representation. A customised allocation according to the invention of cell boundaries and/or areas to different mobile terminals must be realised with the corresponding adjustments to the actual cell boundaries.

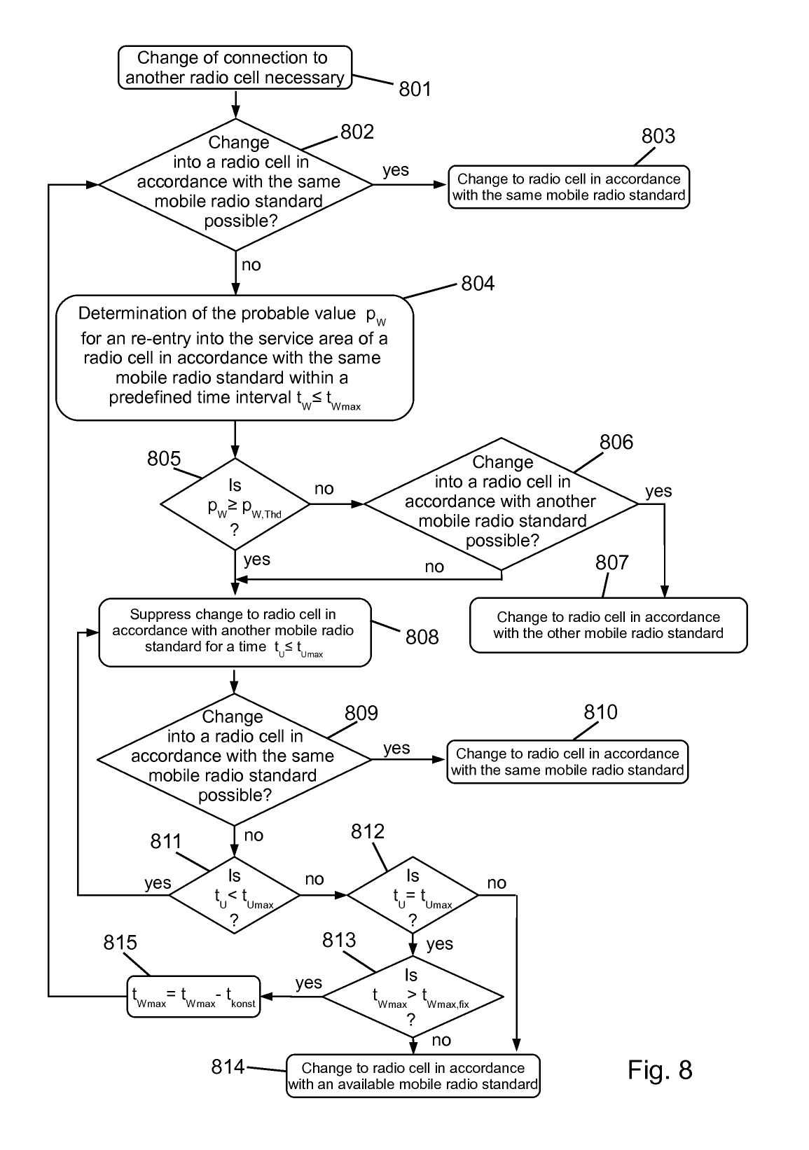

FIG. 8 shows a beneficial design of a method according to the invention in the form of a flow diagram. The starting point of the representation is that the signal quality in relation to a radio cell in accordance with a first mobile radio standard used by a mobile terminal necessitates a change of connection to another radio cell during an ongoing data connection (in FIG. 8 referenced as 801).

The requirement for a change of connection can preferentially occur by entry into an area of the radio cell in which the signal level is below a predefined value, as explained in connection with FIG. 6 and FIG. 7 (not shown in FIG. 8). Moreover, according to another beneficial design of the method according to the invention, it is provided that furthermore, the direction of movement and/or the velocity of movement of the mobile terminal is taken into account, in particular in order to determine, taking account of these data and of the signal quality or the strength of the signal level in relation to the used radio cell, for which time period a use of the currently used radio cell is still possible. If the determined time period falls below a predefined value, for instance 10 seconds, this fact will, in accordance with this beneficial design of the method according to the invention, be used as a criterion for the necessity of a change of connection to another radio cell (not shown in FIG. 8).

If the necessity for a change of connection to another radio cell has been determined, preferentially in the manner described above (referenced as 801 in FIG. 8), it will initially be verified in a step 802 whether a change to another radio cell in accordance with the same mobile radio standard is possible. If this is the case, a change to this radio cell will be performed (referenced as 803 in FIG. 8). If a change to a radio cell in accordance with the same mobile radio standard is not possible, a probable value p_{W} will be determined in another step 804 of the method according to the invention. This probable value p_{W} indicates the probability of a re-entry into the service area of a radio cell in accordance with the same mobile radio standard within a predefined time interval t_{W}. According to the invention, this time interval t_{W} can be set, preferably by the mobile terminal and/or by the mobile radio network, and preferentially has a length between 20 and 30 seconds.

The probable value is determined using location-related information items regarding the service areas, preferentially taking account of cell boundaries allocated to particular areas by geographical coordinates, and using information items regarding the local position of the mobile terminal. Herein, information items relating to the local position of the mobile terminal are preferentially geographical coordinates of the current local position of the mobile terminal, the velocity by which the mobile terminal is moving, preferentially averaged over a defined time period, the direction in which the mobile terminal is changing its local position, and a history of these information items. Based on this information, a period is determined which is required by the mobile terminal for re-entry into the service area of a radio cell corresponding to the same mobile radio standard. This period, in another beneficial design variant supplemented by an additive corrective factor, is preferentially equated with the period which, in accordance with a calculation, is required by the mobile terminal in order to get from the cell boundary of the currently used radio cell to the cell boundary of a radio cell in accordance with the same mobile radio standard. The determination of the probable value p_{W} for re-entry into the service area of a radio cell in accordance with the same mobile radio standard within a time interval t_{W} preferentially depends on how strongly the information items regarding the local position of the mobile terminal vary within a particular time interval. If the velocity by which the mobile terminal is changing its local position and the direction in which the mobile terminal is changing its local position remain essentially constant during a time interval, the probable value p_{W} will be higher than if the velocity by which the mobile terminal is changing its local position and/or the direction in which the mobile terminal is changing its local position are varying strongly, in which case a determination of a next radio cell, as described in connection with FIG. 4 and FIG. 5, can be performed less accurately.

In another process step 805, it is verified according to the invention whether the determined probable value p_{W} is higher than or equal to a predetermined threshold value p_{W,Thd}, i.e. whether the probability of a re-entry into the service area of a radio cell in accordance with the same mobile radio standard within a predefined time interval t_{W} will exceed a predetermined value. In the event that the evaluation should show that this is not the case, it will be verified in a step 806 whether a change to a radio cell in accordance with a different mobile radio standard is possible, and if so, a change to that radio cell will be performed in a step 807.

If, however, the probable value p_{W} is higher than or equal to the threshold value p_{W,Thd}, or if a change to a radio cell in accordance with a different mobile radio standard is not possible, a change to a radio cell in accordance with a different mobile radio standard will be suppressed in a process step 808 for a time period t_{U}, wherein the change to another radio cell will be suppressed for a time period of maximally t_{μmax}. In the time interval during which a change to a radio cell of a different mobile radio standard is suppressed, it is verified in a process step 809 whether a change to a radio cell in accordance with the same mobile radio standard is possible. If this is the case, a change to that radio cell is initiated in a process step 810. Otherwise, it is verified in a step 811 whether the time period t_{U}, for which a change to another radio cell in accordance with a different mobile radio standard has already been suppressed, is even shorter than the maximum time period t_{Umax}, for which a change to a radio cell in accordance with a different mobile radio standard is to be maximally suppressed. If t_{U} is even shorter than t_{Umax}, the change to a radio cell in accordance with a different mobile radio standard will be continued to be suppressed (referenced as 808 in FIG. 8), and it will be continued to be verified whether a change to a radio cell in accordance with the same mobile radio standard is possible (referenced as 809 in FIG. 8). If the time period t_{U} is equal to the maximum time period t_{Umax} (referenced as 812 in FIG. 8), and accordingly no change to a radio cell in accordance with the same mobile radio standard has occurred yet, on principle a change to a radio cell in accordance with a different mobile radio standard could be permitted according to the invention. Since it is highly probable, however, that the mobile terminal has already approached a cell boundary of a radio cell in accordance with the same mobile radio standard, it is provided in accordance with the beneficial design variant of a method according to the invention described in FIG. 8 that again, a probable value p_{W} for a re-entry into the service area of a radio cell in accordance with the same mobile radio standard within a time interval t_{W} is determined. In order to take account of the fact that a change to a radio cell in accordance with a different mobile radio standard will possibly be suppressed again, and the mobile terminal is therefore sometimes not connected to a mobile radio network for a longer period of time, the time interval t_{W} will be reduced in a process step 815 by the constant time period tₖₒₙₛₜ. The duration of time period tₖₒₙₛₜ is preferentially a few seconds, preferentially 5 seconds. The process will be repeated starting from process step 802, with the time interval t_{W} reduced by the time period tₖₒₙₛₜ. A repeated execution of the method starting with process step 802 after a suppression of a change to a radio cell in accordance with a different mobile radio standard for a time period t_{Umax} will occur as long as the time interval t_{W} is longer than a predefined minimum time interval t_{Wmin}. In a beneficial design of the method according to the invention, the minimum time interval t_{Win} is 4 seconds. A verification whether the time interval t_{W} is longer than the minimum time interval t_{Wmin} is performed in process step 813. If the process has already been repeated several times, so that due to the reduction in process step 815, the time interval t_{W} is not longer any more than the minimum time interval t_{Wmin}, it is provided that in accordance with process step 814, the mobile terminal changes to a radio cell in accordance with an available mobile radio standard.

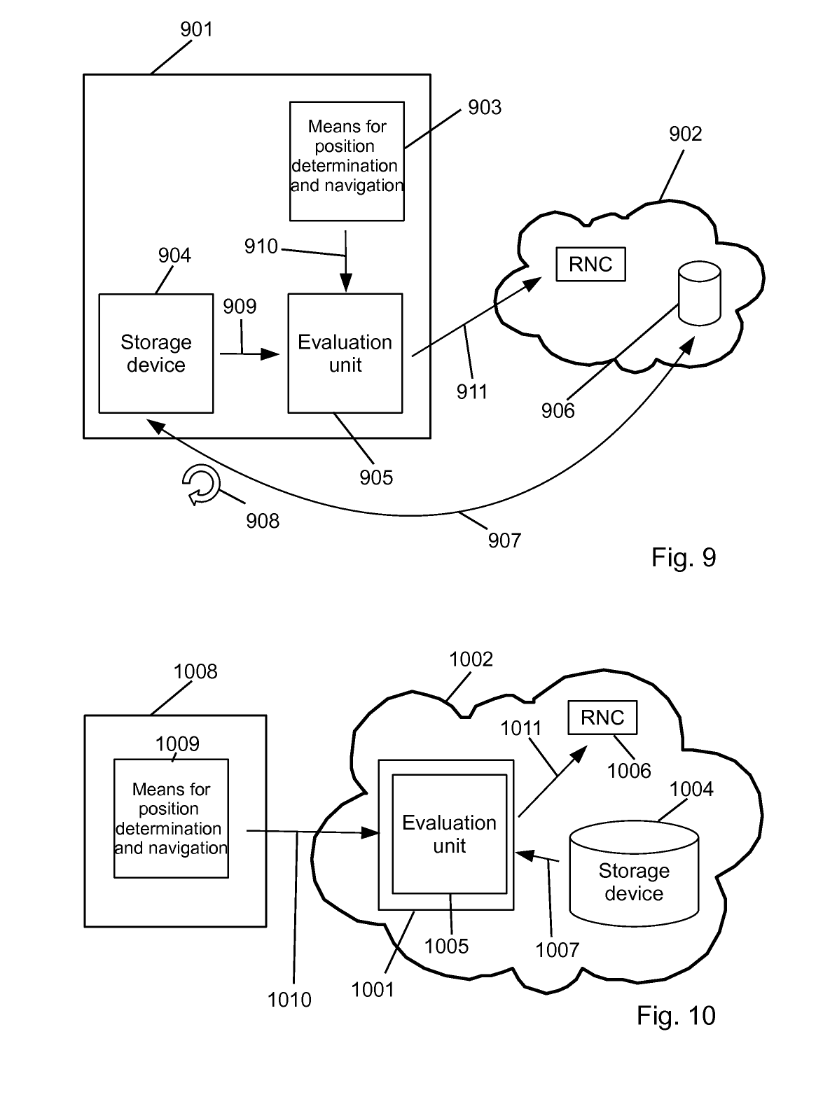

FIG. 9 shows a strongly simplified schematic representation of an exemplary embodiment of a mobile terminal 901 according to the invention for operation in a mobile radio network, and a mobile radio network 902 (represented schematically as a cloud). The mobile terminal 901 in the present case is to be a mobile telephone. For reasons of clarity, the usual components of a mobile telephone are not shown. The mobile terminal 901 is designed to be operated in a mobile radio network in accordance with a first mobile radio standard and in at least one other mobile radio network in accordance with another mobile radio standard, in particular in a UMTS and a GSM mobile radio network. The mobile terminal 901 comprises means 903 for satellite-based position determination and navigation, in particular a GPS receiver. Furthermore, the mobile terminal 901 comprises a storage device 904 in the form of a flash memory for the storage of location-related information items with regard to the service areas of radio cells in accordance with a first mobile radio standard, in particular of the lines of cell boundaries of radio cells in accordance with the first mobile radio standard. The mobile terminal 901 further comprises an evaluation unit 905 which is designed to perform an evaluation regarding a re-entry of the mobile terminal into the service area of a radio cell in accordance with a first mobile radio standard within a predefined time interval, to determine based on the evaluation after what time interval a re-entry of the mobile terminal into the service area of a radio cell in accordance with the first mobile radio standard will occur, to compare the time interval with a predefined time interval, to suppress—upon determination that the time interval is shorter than or equal to the predefined time interval—a change of connection of the mobile terminal to a radio cell in accordance with the second mobile radio standard and, upon re-entry of the mobile terminal into the service area of a radio cell in accordance with the first mobile radio standard within the predefined time interval, to initiate a set-up of a connection to this radio cell. In the present case, the processor of the mobile terminal 901 is used as evaluation unit 905.

The location-related information items regarding the service areas of radio cells in accordance with the first mobile radio standard are supplied to the storage device 904 by a database 906 of the mobile radio network 902, in FIG. 9 symbolically represented by arrow 907. Corresponding location-related information items regarding the service areas of radio cells in accordance with the first mobile radio standard are synchronised at certain time intervals between the mobile terminal 901 and the mobile radio network 902, which is symbolically represented by arrow 908 in FIG. 9. The storage device 904 supplies the location-related information items regarding the service areas of radio cells in accordance with the first mobile radio standard to evaluation unit 905, which is symbolically represented by arrow 909. Furthermore, information items regarding the local position of the mobile terminal 901 are supplied using the GPS receiver 903 of evaluation unit 905, which is symbolically represented by arrow 910. The mobile terminal 901 uses the result of an evaluation performed by means of evaluation unit 905 in order to initiate a change of connection to a radio cell, in particular in order to suppress a so-called intersystem handover from a UMTS radio cell to a GSM radio cell, if the evaluation performed has shown that a re-entry into a UMTS radio cell will occur within a predefined time interval. For this purpose, the mobile terminal is designed to send a corresponding command (symbolically represented by arrow 911 in FIG. 9) to the mobile radio network, for instance to the radio network controller (RNC), which command will suppress a change from a UMTS radio cell to a GSM radio cell initiated by the mobile radio network.

FIG. 10 shows a strongly simplified schematic diagram of a device 1001 according to the invention of a mobile radio network 1002. The device 1001 comprises means for executing at least one of the methods suggested by the present invention. The device 1001 is designed to exchange data with other devices of the mobile radio network within the scope of execution of the method according to the invention, in particular with a database 1004 of the mobile radio network 1002, and with so-called radio network controllers (RNC) 1006. Accordingly, the device 1001 is supplied by the database 1004 with location-related information items regarding the service areas of radio cells in accordance with a UMTS mobile radio standard (symbolically represented by arrow 1007 in FIG. 10). Moreover, the device 1001 is preferentially supplied with information items regarding the performance of a handover (not explicitly shown in FIG. 10).

Moreover, information items regarding the local position of the mobile terminal 1008 are transmitted to the device 1001 by a mobile terminal 1008 operable in the mobile radio network 1002 (symbolically represented by arrow 1010 in FIG. 10), which mobile terminal comprises means 1009 for position determination.

The device 1001 of the mobile radio network 1002 further comprises an evaluation unit 1005 which is configured to perform an evaluation regarding a re-entry of the mobile terminal 1008 into the service area of a radio cell in accordance with the UMTS mobile radio standard occurring within a predefined time interval, to determine—based on the evaluation—within which time interval a re-entry of the mobile terminal 1008 into the service area of a radio cell in accordance with the UMTS mobile radio standard will occur, to compare the time interval with a predefined time interval and, upon determination that the time interval is shorter or equal to the predefined time interval, to suppress a change of connection of the mobile terminal 1008 to a radio cell in accordance with a different mobile radio standard. In order to suppress a change of connection, the device 1001 is presently designed to send a command to another device of the mobile radio network 1002 involved in a change of connection from a UMTS radio cell to a GSM radio cell, which command will cause the respective device to suppress a change of connection of the mobile terminal 1008 to a radio cell in accordance with the GSM mobile radio standard. The sending of the command is symbolically represented by the arrow 1011 in FIG. 10. Moreover, upon re-entry of the mobile terminal 1008 into the service area of a radio cell in accordance with the UMTS mobile radio standard within the predefined time interval, the device 1001 of the mobile radio network 1002 is configured to initiate a set-up of a connection between the mobile terminal 1008 and this radio cell (not explicitly shown in FIG. 10).

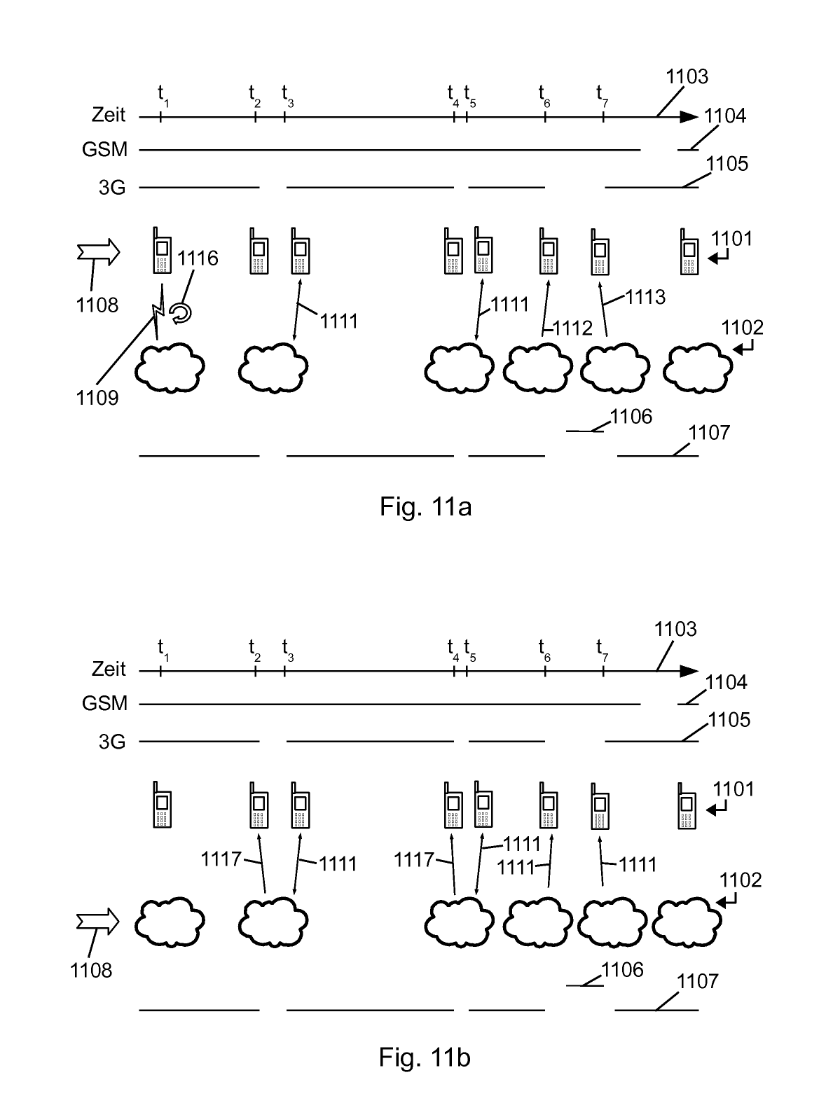

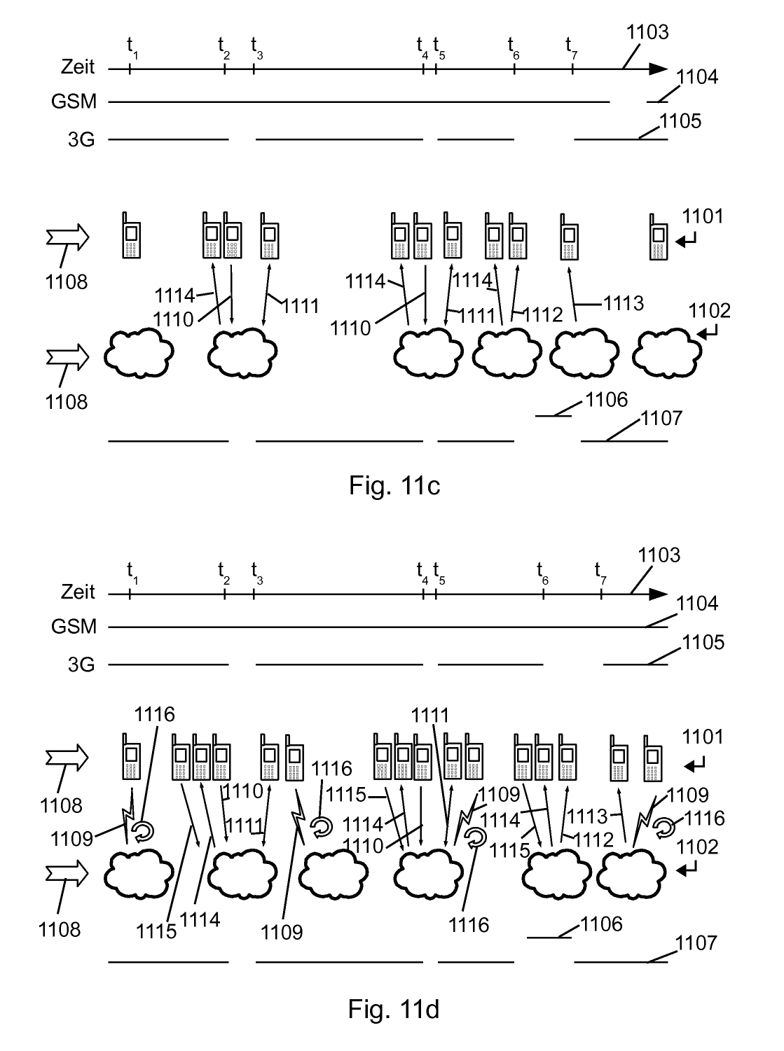

Each of FIG. 11a to FIG. 11d shows a simplified schematic representation of different design variants of the method according to the invention. In this context, FIG. 11a to FIG. 11b schematically show a mobile terminal 1101 and a mobile radio network 1102 at different time instants, in particular at time instants where an interaction between the mobile telephone and the mobile radio network takes place. As provided according to the invention, the mobile telephone 1101 uses the mobile radio network 1102 for a data connection (not explicitly shown in FIG. 11a to FIG. 11b), wherein the mobile telephone 1101 is configured both for operation in accordance with the UMTS mobile radio standard and for operation in accordance with the GSM mobile radio standard. Moreover, FIG. 11a to FIG. 11d show a time line 1103 with different time instants. Since the representation is purely schematic, no actual real times can be derived from the distances between the time instants in the present case. The line 1104 below the time line symbolises the availability of a GSM mobile radio network in relation to the time line 1103, wherein an interruption of the line 1104 symbolises a non-availability of the GSM mobile radio network. The line 1105 arranged further below correspondingly symbolises the availability of a UMTS mobile radio network in relation to time line 1103. Interruptions of line 1105 correspondingly symbolise a non-availability of the UMTS mobile radio network. In addition, the presence of a line 1106 in relation to the time line 1103 symbolises when the mobile telephone 1101 is using the GSM mobile radio network, and the presence of a line 1107 symbolises when the mobile telephone 1101 is using the UMTS mobile radio network. If in relation to time line 1103, neither a line 1106 nor a line 1107 is present for a time segment, this symbolises that the mobile terminal is not connected with the mobile radio network 1102.

Moreover, the arrow 1108 marks which component, i.e. mobile telephone 1101 and/or mobile radio network 1102, is essentially involved in the execution of the method according to the invention.

For reasons of clarity, individual radio cells of the UMTS mobile radio network or of the GSM mobile radio network are not shown. It is understood, however, that in the event of availability 1104 of the GSM mobile radio network or in the event of availability 1105 of the UMTS mobile radio network, corresponding radio cells are present, and that upon corresponding availability, the mobile telephone 1101 is present in the service area of corresponding radio cells.

In FIG. 11a, as suggested by the arrow 1108, a method according to the invention is carried out essentially by the mobile telephone 1101. Initially, at a time instant t₁, a transmission 1109 (symbolically represented by a flash in FIG. 11a) of location-related information items regarding the service areas of UMTS radio cells for a defined geographical area takes place. Herein, the other arrow 1116 symbolises a synchronisation of location-related information items already available on the part of mobile telephone 1101 with regard to the service areas of radio cells in accordance with the UMTS mobile radio standard with location-related information items correspondingly supplied by mobile radio network 1102.

In the time segment between t₁ and t₂, the mobile telephone 1101 is present in the service area both of the UMTS mobile radio network and of the GSM mobile radio network, which is symbolically shown by the lines 1105 and 1104, respectively. In this time segment, the mobile telephone 1101 uses the UMTS mobile radio network for a data connection, which is symbolically shown by the line 1107. Approximately at the time instant t₂, the signal quality in relation to the used radio cell of the UMTS mobile radio network necessitates a change of connection to another radio cell during the ongoing data connection. Induced thereby, the mobile telephone 1101 performs an evaluation regarding a re-entry into the service area 1105 of a radio cell in accordance with the UMTS mobile radio standard within a predefined time interval, using previously received location-related information items regarding the service areas of radio cells in accordance with the UMTS mobile radio standard and using information items regarding the local position of the mobile telephone 1101 recorded by means of the mobile telephone 1101. Herein, the predefined time interval is longer than the time segment defined by the time instants t₂ and t₃. The evaluation performed by the mobile telephone 1101 leads to the determination that a re-entry into the service area 1105 of a radio cell in accordance with the UMTS mobile radio standard will occur within the predefined time interval. The mobile telephone 1101 suppresses a change of connection to a radio cell in accordance with the GSM mobile radio standard. Consequently, as soon as the UMTS mobile radio network is not available any more, the data connection is interrupted, and the mobile telephone 1101 is not connected with the mobile radio network 1102 during the time segment defined by the time instants t₂ and t₃.

As soon as the UMTS mobile radio network is available again, a cell reselection 1111 will occur, i.e. a connection between the mobile telephone 1101 and the mobile radio network 1102 will be set up, and the data connection will be restored.

The described process is repeated in relation to the time segment defined by the time instants t₄ and t₅.

Also at the time instant t₆, i.e. a short time before that, an evaluation in accordance with the invention is performed by the mobile telephone 1101. Herein, the evaluation leads to the determination that a re-entry into the service area 1105 of a radio cell in accordance with the UMTS mobile radio network will not occur within the predefined time interval. Consequently, a suppression of a change of connection according to the invention initiated by the mobile telephone 1101 will not occur. Therefore, the mobile telephone 1101 will initiate a change of the mobile radio system 1112 at, or shortly after, the time instant t₆, causing a change of connection from a UMTS radio cell to a GSM radio cell, as described in connection with FIG. 2. Starting from the time instant t₇, the UMTS mobile radio network is available again (1105), so that mobile telephone 1101 will again initiate a change of the mobile radio system 1113, whereupon a change of connection from a GSM radio cell to a UMTS radio cell will occur, as also described in connection with FIG. 2.

In FIG. 11b, as suggested by the arrow 1108, a method according to the invention is carried out essentially by the mobile radio network 1102. For this purpose, the mobile radio network 1102 accesses a database (not explicitly shown in FIG. 11b) supplying location-related information items regarding the service areas of radio cells in accordance with the UMTS mobile radio standard. The mobile telephone 1101 preferentially determines information items regarding the local position of the mobile telephone 1101 by evaluating the direction and the velocity of regular changes of radio cells within the UMTS mobile radio network. Preferentially, it is not necessary to supply corresponding location-related information items on the part of the mobile telephone 1101, so that the method according to the invention can preferentially also be carried out using mobile terminals that do not have means for local position determination.

According to the representation in FIG. 11b, the mobile telephone 1101 is present in the service area both of the UMTS mobile radio network and of the GSM mobile radio network in the time segment between t₁ and t₂, which is symbolically shown by the lines 1105 and 1104. In this time segment, the mobile telephone 1101 uses the UMTS mobile radio network for a data connection, which is symbolically shown by the line 1107. Approximately at the time instant t₂, the signal quality in relation to the used radio cell of the UMTS mobile radio network necessitates a change of connection to another radio cell during the ongoing data connection, which is preferentially communicated to the mobile radio network 1102 by the involved Node B (not explicitly shown in FIG. 11b). Induced thereby, the mobile radio network 1102 or a device of the mobile radio network 1102 performs an evaluation regarding a re-entry into the service area 1105 of a radio cell in accordance with the UMTS mobile radio standard within a predefined time interval, using the location-related information items regarding the service areas of radio cells in accordance with the UMTS mobile radio standard and using determined information items regarding the local position of the mobile telephone 1101. Herein, the predefined time interval is longer than the time segment defined by the time instants t₂ and t₃. The evaluation performed by the mobile radio network 1102 leads to the determination that a re-entry into the service area 1105 of a radio cell in accordance with the UMTS mobile radio standard will occur within the predefined time interval. Therefore, the mobile radio network 1102 will not initiate a change of connection to a radio cell in accordance with the GSM mobile radio standard, but will send a command to the mobile telephone 1101 not to perform a change of connection to a radio cell in accordance with the GSM mobile radio standard. As soon as the UMTS mobile radio network is not available any more, the data connection is interrupted, and the mobile telephone 1101 is not connected with the mobile radio network 1102 during the time segment defined by the time instants t₂ and t₃.

As soon as the UMTS mobile radio network is available again (1105), a cell reselection 1111 will occur, i.e. a connection between the mobile telephone 1101 and the mobile radio network 1102 will be set up again, and the data connection will be restored.

The described process is repeated in relation to the time segment defined by the time instants t₄ and t₅.

An evaluation according to the invention will also be performed by the mobile radio network 1102 a few seconds before the time instant t₆. Here, the evaluation leads to the determination that a re-entry into the service area 1105 of a radio cell in accordance with the UMTS mobile radio standard will not occur within the predefined time interval. A suppression of a change of connection according to the invention will therefore not take place. Therefore, the mobile telephone 1101 will initiate a cell reselection 1111 (intersystem handover) approximately at the time instant t₆, causing a change of connection from a UMTS radio cell to a GSM radio cell, as described in connection with FIG. 2. Starting from the time instant t₇, the UMTS mobile radio network is available again (1105), so that mobile telephone 1101 will again initiate a cell reselection 1111 (intersystem handover), whereupon a change of connection from a GSM radio cell to a UMTS radio cell will occur, as also described in connection with FIG. 2.

In FIG. 11c, as suggested by the arrows 1108, a method according to the invention is carried out both using the mobile telephone 1101 and on the part of mobile radio network 1102, wherein the mobile telephone 1101 and the mobile radio network 1102 quasi form a system for executing a method according to the invention. In the design shown in FIG. 11c, the evaluation according to the invention regarding a re-entry into the service area of a radio cell in accordance with the UMTS mobile radio standard within a predefined time interval, as explained in connection with FIG. 11b, is carried out by the mobile radio network 1102 or by a device of the mobile radio network 1102. In contrast to the design variant explained in connection with FIG. 11c, the result of the evaluation is transmitted to the mobile telephone 1101. Depending on the result of the evaluation, the mobile telephone 1101 will send a command, symbolically represented by the arrow 1110, to the mobile radio network 1102. The reception of the command by the mobile radio network 1102 or by a device of the mobile radio network 1101 prevents that the mobile radio network 1102 initiates a change of connection to another radio cell. A corresponding command 1110 is sent in FIG. 11c approximately at the time instants t₂ and t₄ to the mobile radio network 1102. At the time instant t₆, no command is sent to mobile radio network 1102, since the evaluation performed by the mobile radio network has shown that a re-entry into the service area 1105 of the UMTS mobile radio network will not occur within the predefined time interval. Accordingly, the mobile radio network 1102 will initiate a cell reselection (intersystem handover) 1112 a few seconds after the time instant t₆.

Also in FIG. 11d, as suggested by the arrows 1108, a method according to the invention is carried out both using the mobile telephone 1101 and using the mobile radio network 1102 or a device of the mobile radio network 1102, wherein the mobile telephone 1101 and the mobile radio network 1102 interact as a system in order to execute the method according to the invention.

According to this design variant according to the invention shown in FIG. 11d, it is provided, in contrast to the design in accordance with FIG. 11c, that the mobile telephone 1101 records information items regarding the availability of the UMTS mobile radio network, in particular regarding location-related cell boundaries of the UMTS mobile radio network. These recorded information items (not explicitly shown in FIG. 11d) are, in particular after a cell reselection 1111 has been performed, exchanged or synchronised (symbolised by the arrow 1116) between a storage device of the mobile telephone 1101 and a corresponding database (not explicitly shown in FIG. 11d) of the mobile radio network 1102 supplying corresponding location-related information items regarding the service areas of radio cells in accordance with the UMTS mobile radio standard. The recorded information items are stored by the database or used for an adjustment of already existing location-related information items regarding the service areas of radio cells in accordance with the UMTS mobile radio standard.

Deviations in relation to location-related information items recorded by the mobile telephone 1101 regarding the service areas of radio cells in accordance with the UMTS mobile radio standard and location-related information items supplied by the database of mobile radio network 1102 regarding the service areas of radio cells in accordance with the UMTS mobile radio standard are at least partly automatically taken into account in the evaluation performed by the mobile radio network 1102 and optionally in the definition of the time interval within which a re-entry into the service area of the radio cell in accordance with the first mobile radio standard is to take place. For this purpose, the mobile radio network 1102 preferentially makes use of so-called self-learning systems.

Another difference in the design in accordance with FIG. 11d in comparison with the design in accordance with FIG. 11c is that the information items regarding the local position are determined by the mobile telephone 1101 in the design in accordance with FIG. 11d and are transmitted to the mobile radio network 1102 (represented by the arrow 1115 in FIG. 11d) at least if a reduction of signal quality in relation to the used radio cell is recorded by the mobile telephone 1101 which suggests that a change of connection to another radio cell will be required during the ongoing data connection. Herein, the mobile radio network 1102 will then use the information items supplied by the mobile telephone 1101 regarding the local position of the mobile telephone 1101 for the evaluation in accordance with the invention as described in connection with FIG. 8.

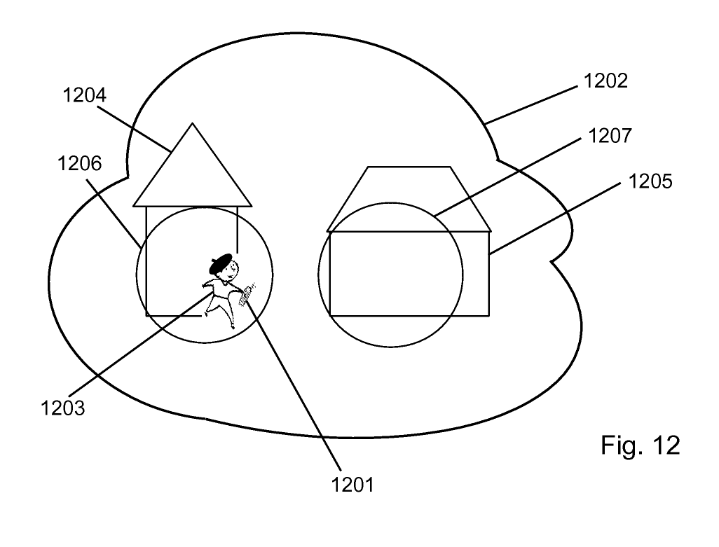

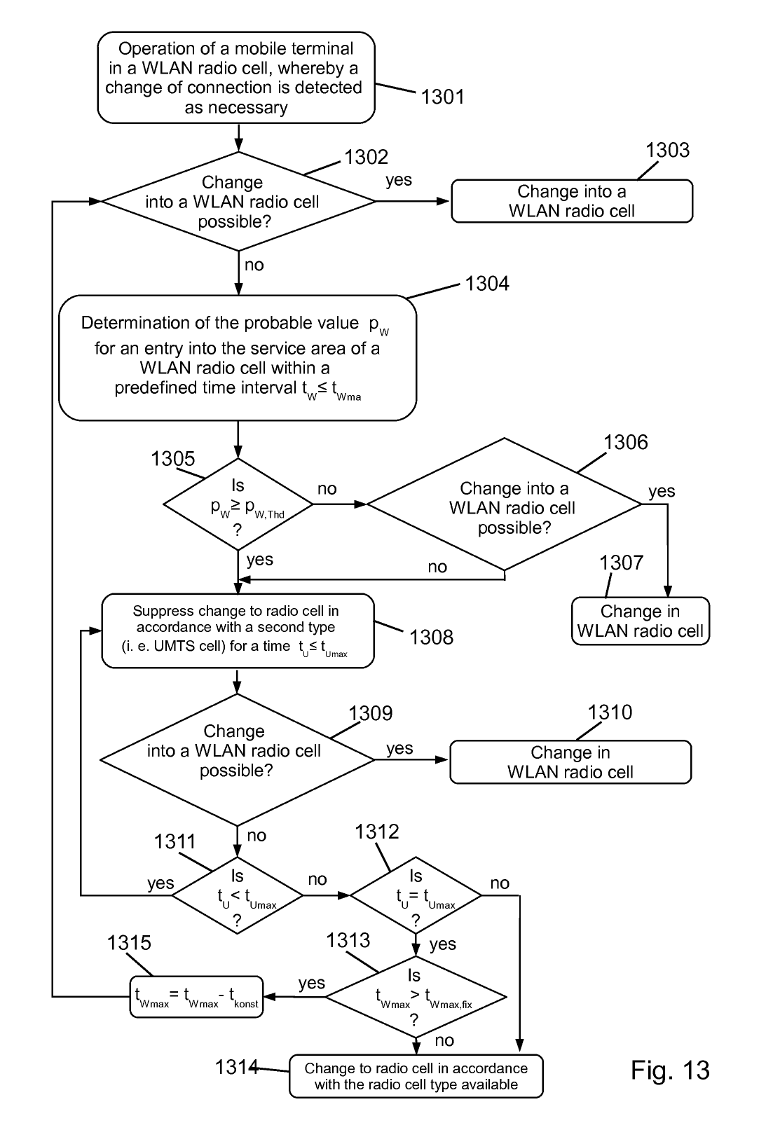

With reference to FIG. 12 and FIG. 13, another exemplary embodiment of a method according to the invention for operation of a mobile terminal operable in at least one communication network for a change of connection in a communication network is explained in more detail, wherein radio cells of a first type and radio cells of a second type are formed by at least one communication network. The method comprises in particular the following steps:

evaluating an information item regarding the local position of the mobile terminal in a service area of a radio cell of the first type with regard to an entry of the mobile terminal into the service area of a radio cell of the first type, which entry is to be expected within a predefined time interval; and

suppressing a change of connection of the mobile terminal to a radio cell of the second type if, based on the result of the evaluation, the entry of the mobile terminal into the service area of the radio cell of the first type can be expected within the predefined time interval.

The mobile terminal 1201 in the present case is a mobile telephone, which can be operated both in a mobile radio network 1202 and in local radio networks 1206 and 1207. The mobile terminal 1201 is operable in particular in a mobile radio network in accordance with a GSM, UMTS, and/or LTE mobile radio standard and in WLANs, in particular WLANs in accordance with a standard of the IEEE 802.11 family.

The buildings 1204 and 1205 shown in FIG. 12 are present in the service area of UMTS radio cells of mobile radio network 1202 (the radio cells are not explicitly shown in FIG. 12). To that extent, the mobile radio network 1202 forms radio cells in accordance with a UMTS mobile radio standard as radio cells of a first type. Moreover, in each of building 1204 and building 1205 is a device not shown in the figure which forms a WLAN 1206 and 1207, respectively, as a communication network. Herein, the respective WLAN 1206 and 1207 constitutes a radio cell of the second type in the form of a WLAN radio cell. In building 1204 which, in the present case, is the house of user 1203, the mobile terminal 1201 can on principle use a data connection via a UMTS radio cell or via the WLAN radio cell 1206.

In the present case, a data connection in a WLAN radio cell 1206 or 1207 provides a greater bandwidth than a data connection in a UMTS radio cell. Moreover, in the present case the utilisation of a data connection in a WLAN radio cell 1206 or 1207 is more cost-effective for the user 1203. For these reasons, the mobile terminal 1201 in building 1204 of user 1203 uses the WLAN radio cell 1206 for a data connection. The boundary lines of the radio cells 1206 and 1207 shown in FIG. 12 in the present case constitute the cell boundaries of the radio cells and therefore symbolically indicate the boundaries of the transmission/reception range of the respective WLAN network 1206 and 1207.

In accordance with the exemplary embodiment shown in FIG. 12, it is provided that the mobile terminal 1201 uses the WLAN radio cell 1206 in order to load data, for instance video data, from the Internet to the mobile terminal 1201. During the utilisation of the data connection, the user 1203 intends to go to the street café 1205 which is located at two minutes walking distance. For this purpose, the user 1203 leaves the house 1204. Although initially, the user is still present in the transmission/reception range of the WLAN network 1206, the mobile terminal 1201 detects, by evaluating an information item regarding the local position of the mobile terminal 1201, that a change of connection to another radio cell will be required. This will initiate an evaluation wherein, taking account of an information item regarding the local position of the mobile terminal 1201 in the service area of the WLAN radio cell 1206 and taking account of location-related information items regarding other WLAN radio cells, a forecast is generated about whether an entry of the mobile terminal 1201 into the service area of another WLAN radio cell 1207 will occur within a time interval of three minutes set by the user 1203. Taking account of the direction of movement of the user 1203 or of the mobile terminal 1201 as well as of its velocity of movement, the mobile terminal 1201 will determine whether the mobile terminal 1201 will enter the service area of a WLAN radio cell within the time interval of three minutes set by the user 1203. Based on the parameters underlying the evaluation, the mobile terminal 1201 or a corresponding evaluation unit of the mobile terminal 1201 will come to the result that the mobile terminal 1201 should be present in the WLAN radio cell 1207 of the street café 1205 within a time interval which is shorter than three minutes. Therefore, the mobile terminal 1201 or a suppression unit of the mobile terminal 1201 will suppress a change of connection to a UMTS radio cell of mobile radio network 1202 upon or after leaving the service area of WLAN radio cell 1206. As soon as user 1203 is present in the service area of WLAN radio cell 1206 within the time interval of three minutes, the mobile terminal 1201 will use the WLAN radio cell 1207 for a data connection, and will load the other video data from the Internet to the mobile terminal 1201.

An exemplary embodiment of the basic sequence of the process in accordance with the invention is shown in FIG. 13. The starting point may for instance be the leaving of the house 1204 by user 1203 with his mobile terminal 1201 shown in FIG. 12 (represented by reference numeral 1301 in FIG. 13). If the mobile terminal has detected the necessity for a change of connection to another radio cell, it will initially verify whether a change to another WLAN radio cell for a data transfer is possible (process step 1302). If this is the case, the mobile terminal will cause a change to this WLAN radio cell (process step 1303). Otherwise, as for instance in the case of the exemplary embodiment shown in FIG. 12, it is provided that an evaluation unit of the mobile terminal determines a probable value p_{W} for an entry into the service area of a WLAN radio cell within a time interval t_{W}≦t_{Wmax} (process step 1304). In the exemplary embodiment shown with reference to FIG. 12, the predefined time interval t_{Wmax} is three minutes. With further reference to FIG. 12, the time interval t_{W} will be less than two minutes, since the walking time between the house 1204 of user 1203 and the street café 1205 is two minutes, wherein the distance between the cell boundaries of the WLAN radio cells 1206 and 1207 is less than the distance between the buildings 1204 and 1205. Since the time interval t_{W} is therefore considerably shorter than the time interval t_{Wmax}, the calculated probable value p_{W} will be clearly above the threshold value p_{W,Thd}. A corresponding adjustment of the probable values p_{W} with p_{W,Thd} in process step 1305 will therefore have the result that in accordance with process step 1308, a change to a UMTS radio cell of mobile radio network 1202 for a period t_{U}, which is shorter than a predefined other period t_{Umax}, will be suppressed. In the present case, t_{Umax} is 210 seconds. During the period t_{U}<t_{Umax}, it will be verified in a process step 1309 whether a change to a WLAN radio cell is possible until the period t₀ exceeds the predefined period t_{Umax}. This will be verified in a process step 1311. In accordance with the exemplary embodiment shown in connection with FIG. 12, it is provided, however, that a change to a WLAN radio cell 1207 is possible already after less than two minutes. For this reason, a change to the WLAN radio cell 1207 will occur in accordance with process step 1310. If a corresponding change to a WLAN radio cell was not possible within the period t_{U}<t_{Umax}, at least some of the further shown process steps 1312 to 1315 would be carried out analogously to the process steps 812 to 815, which are explained in connection with FIG. 8.

The exemplary embodiments of the invention represented in the figures and described in connection with the same only serve to explain the invention and are in no way restrictive for the same.

### LIST OF REFERENCE NUMERALS

101 Cell level of the first radio cell of the UMTS mobile radio network
102 Cell level of the second radio cell of the UMTS mobile radio network
201 Cell level of the first radio cell of the UMTS mobile radio network
202 Cell level of the second radio cell of the UMTS mobile radio network
203 Time span with poorer data transmission
301 Cell level of the first radio cell of the UMTS mobile radio network
302 Cell level of the second radio cell of the UMTS mobile radio network
303 Time span without connection to the mobile radio network
401 Radio cell of the UMTS mobile radio network used by the mobile terminal
402 Radio cell of the GSM mobile radio network
403 Radio cell of the UMTS mobile radio network determined for further use
404 Other radio cell of the UMTS mobile radio network
405 Other radio cell of the UMTS mobile radio network
406 Other radio cell of the UMTS mobile radio network
407 Local position of the mobile terminal
408 Distance travelled by the mobile terminal
409 Direction of movement of the mobile terminal
410 Area in which the mobile terminal is not connected with the mobile radio network
501 Radio cell of the UMTS mobile radio network used by the mobile terminal
502 Radio cell of the GSM mobile radio network
503 Radio cell of the UMTS mobile radio network (target cell)
504 Other radio cell of the UMTS mobile radio network
505 Other radio cell of the UMTS mobile radio network determined for further use
506 Other radio cell of the UMTS mobile radio network
507 Local position of the mobile terminal
508 Distance travelled by the mobile terminal
509 Direction of movement of the mobile terminal
510 Area in which the mobile terminal is not connected with the mobile radio network
511 Road
601 Radio cell of a mobile radio network
602 Cell boundary for mobile terminals A
603 Cell boundary for mobile terminals B
604 Cell boundary for mobile terminals C
605 Area for mobile terminals A where the signal level of cell (601) has fallen below a defined value
606 Area for mobile terminals B where the signal level of cell (601) has fallen below a defined value
607 Area for mobile terminals C where the signal level of cell (601) has fallen below a defined value
701 Radio cell of a mobile radio network
702 Cell boundary for mobile terminals D
703 Cell boundary for mobile terminals E
704 Area for mobile terminals D where the signal level of cell (701) has fallen below a defined value
705 Area for mobile terminals E where the signal level of cell (701) has fallen below a defined value
801-815 Show process steps of an exemplary embodiment of the method according to the invention
901 Mobile terminal
902 Mobile radio network
903 Means for position determination and navigation
904 Storage device
905 Evaluation unit
906 Database (of mobile radio network 902)
907 Synchronisation of location-related information items regarding the service areas of radio cells in accordance with the first mobile radio standard
908 Synchronisation of location-related information items regarding the service areas of radio cells in accordance with the first mobile radio standard
909 Provision of location-related information items regarding the service areas of radio cells in accordance with the first mobile radio standard by the storage device to the evaluation unit
   Provision of information items regarding the local position of the mobile terminal (901) to the evaluation unit
   Sending of a command from mobile terminal 901 to mobile radio network 902
1001 Device (of mobile radio network 1002)
1002 Mobile radio network
1004 Database (of mobile radio network 1002)
1005 Evaluation unit
1006 Radio network controller
1007 Provision of location-related information items regarding the service areas of radio cells in accordance with the UMTS mobile radio standard
1008 Mobile terminal
1009 Means for position determination
1010 Provision of information items regarding the local position of the mobile terminal
Sending of a command from device 1001 to another device of the mobile radio network 1002
1101 Mobile telephone
1102 Mobile radio network
1103 Time line
1104 Availability of the GSM mobile radio network
1105 Availability of the UMTS mobile radio network
1106 Utilisation of the GSM mobile radio network
1107 Utilisation of the UMTS mobile radio network
1108 Involved in the execution of the method
1109 Transmission of location-related information items regarding the service areas of radio cells in accordance with the UMTS mobile radio network
1110 Command for suppressing a change to a radio cell of the GSM mobile radio network
1111 Cell reselection
1112 Intersystem handover (cell reselection)
1113 Intersystem handover (cell reselection)
1114 Transmission of the result of the evaluation
1115 Transmission of information items regarding the local position of mobile terminal 1101
1116 Synchronisation/adjustment of location-related information items regarding the service areas of radio cells in accordance with the UMTS mobile radio standard
1117 Command not to perform a change of connection to a radio cell in accordance with the GSM mobile radio standard
1201 Mobile terminal
1202 Mobile radio network
1203 User of the mobile terminal (1201)
1204 Building (house of the user)
1205 Building (street café)
1206 WLAN radio cell
1207 WLAN radio cell
1301-1315 Show process steps of an exemplary embodiment of the method according to the invention

What is claimed is:

1. Method for operating a mobile terminal operable in at least one communication network for a change of connection in a communication network, wherein radio cells of a first type and radio cells of a second type are formed by at least one communication network, comprising the following steps:
evaluating an information item regarding the local position of the mobile terminal in a service area of a radio cell of the first type with regard to an entry of the mobile terminal into the service area of a radio cell of the first type, which entry is to be expected within a predefined time interval; and
suppressing a change of connection of the mobile terminal to a radio cell of the second type if, based on the result of the evaluation, the entry of the mobile terminal into the service area of the radio cell of the first type can be expected within the predefined time interval.

2. Method in accordance with claim 1, characterised in that the suppression of the change of connection to a radio cell of the second type is initiated by the mobile terminal.

3. Method in accordance with claim 1, characterised in that the period of the predetermined time interval is between 10 and 30 seconds, between 5 and 40 seconds, or between 1 and 60 seconds.

4. Method in accordance with claim 1, characterised in that the period of the predefined time interval is shorter than the time interval required for a change of connection from a radio cell of the first type to a radio cell of the second type.

5. Method according to the claim 1, characterised in that within the scope of evaluation, a probable value for entry into the service area of a radio cell of the first type is determined, the determined probable value is compared with a predefined limiting value, and a change of connection to a radio cell of the second type is suppressed if the limiting value is exceeded in order to enable the mobile terminal to set up a connection with a radio cell of the first type within the predefined time interval.

6. Method according to claim 1, characterised in that a change of connection to a radio cell of the second type is suppressed for another predefined time interval.

7. Method according to claim 1, characterised in that a data connection in a radio cell of the first type provides a greater bandwidth than a data connection in a radio cell of the second type.

8. Method according to claim 1, characterised in that the evaluation is performed using location-related information items with regard to the service areas of radio cells of the first type, wherein the location-related information items with regard to the service areas of radio cells of the first type comprise information items regarding location-related cell boundaries of the radio cells of the first type.

9. Method according to claim 8, characterised in that the location-related information items regarding the service areas of radio cells of the first type are provided, at least partly, by a storage device of the at least one communication network and/or by a storage device of the mobile terminal.

10. Method according to claim 8, characterised in that information items allocated to the location area of a mobile terminal which information items relate to an entry into the service area of a radio cell of the first type are recorded by the mobile terminal and/or by the at least one communication network as further location-related information items with regard to the service areas of radio cells of the first type.

11. Method according to claim 10, characterised in that the recorded information items comprise information items allocated to a location area with regard to the signal quality of a radio cell of the first type.

12. Method according to claim 10, characterised in that the recorded information items are added to the location-related information items regarding the service areas of radio cells of the first type provided by the storage device of the at least one communication network and/or by the storage device of the mobile terminal, or that already available location-related information items regarding the service area of radio cells of the first type are adjusted, taking the recorded information items into account.

13. Method according to claim 8, characterised in that modifications in relation to location-related information items regarding the service areas of radio cells of the first type are at least partly automatically taken into account in the evaluation and/or definition of the time interval.

14. Method according to claim 8, characterised in that at least the location-related information items regarding the service areas of radio cells of the first type are synchronised between the at least one communication network and the mobile terminal.

15. Method according to claim 1, characterised in that the information items regarding the local position of the mobile terminal comprise at least information items with regard to the current local position of the mobile terminal, with regard to the current direction into which the mobile terminal is changing its local position, with regard to the current velocity by which the mobile terminal is changing its local position, and/or past information items with regard to the local position, direction, and/or velocity.

16. Mobile terminal for operation in at least one communication network, wherein radio cells of a first type and radio cells of a second type are formed by the at least one communication network, characterised by means for carrying out a method according to claim 1.

17. Mobile terminal according to claim 16, characterised by an evaluation unit for evaluating an information item regarding the local position of the mobile terminal in a service area of a radio cell of the first type with regard to an entry of the mobile terminal into the service area of a radio cell of the first type, which entry is to be expected within a predefined time interval.

18. Mobile terminal according to claim 17, characterised by a suppression unit for suppressing a change of connection of the mobile terminal to a radio cell of the second type.

19. Device in a communication network, in particular network nodes in a mobile radio network, wherein radio cells of a first type and radio cells of a second type are formed by the communication network and/or by at least one other communication network, characterised by means for executing a method according to claim 1.

20. Device according to claim 19, characterised by an evaluation unit for evaluating an information item regarding the local position of the mobile terminal in a service area of a radio cell of the first type with regard to an entry of the mobile terminal into the service area of a radio cell of the first type, which entry is to be expected within a predefined time interval.

21. Device according to claim 19, characterised by a suppression unit for suppressing a change of connection of the mobile terminal to a radio cell of the second type.

22. A system comprising at least one device of a communication network, in particular network nodes of a mobile radio network, and a mobile terminal for operation in a communication network, in particular in a mobile radio network, wherein the at least one device of the communication network and the mobile terminal are configured to exchange information with each other, characterised in that the system is configured to execute a method according to claim 1.
